(19) United States
(12) Patent Application Publication
(10) Pub. No.: US 2010/0188962 A1
(43) Pub. Date: Jul. 29, 2010

(54) Optical Pickup Device and Optical Disk Apparatus Using the Same

(75) Inventor: Akihiro Yasuda, Fukuoka (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/693,676

(22) Filed: Jan. 26, 2010

(30) Foreign Application Priority Data
Jan. 28, 2009 (JP) 2009-016198
Mar. 17, 2009 (JP) 2009-063848

(51) Int. Cl. G11B 7/135

(52) U.S. Cl. 369/112.28; 369/112.29; G9B/7.112; G9B/7.128

(57) ABSTRACT

An optical pickup device includes a light source, a movable condensing lens, a rising prism or a rising mirror, an objective lens, and a phase plate. The light source emits laser light, and the movable condensing lens converts the laser light into converging light or diverging light. The rising prism or the rising mirror converts an optical axis of laser light passing through the condensing lens into a substantially vertical direction. The objective lens condenses the laser light, of which the optical axis is converted by the rising prism or the rising mirror, to an optical disk. The phase plate is provided between the condensing lens and the objective lens, and includes stepped portions that are formed at portions facing each other and have different thicknesses. The phase plate corrects astigmatism, which is generated by the rising prism or the rising mirror, by making a part of laser light having a size larger than a predetermined size pass through the stepped portions of the phase plate.

According to the above-mentioned structure, it may be possible to correct the astigmatism of not only laser light directed to the optical disk but also light reflected from the optical disk of which the polarization direction is different by about 90° from that of the laser light directed to the optical disk, without requiring power or a specific system when astigmatism generated by the rising prism, the rising mirror, or the like is corrected.

### BACKGROUND

1. Field of the Invention

The present invention relates to an optical pickup device that performs at least one of the recording or reproduction of information on an optical disk, and an optical disk apparatus using the optical pickup device.

2. Background of the Invention

Examples of an optical disk, which is one object to which the invention is applied, include a CD, a DVD, and a BD (Blu-ray Disc), In terms of the convenience of users, there is a demand for an optical disk apparatus that can perform recording and reproduction on these three kinds of optical disks. Further, a multilayer disk having density higher than a BD has been proposed in recent years, and there has been an optical disk of which the recording layer in which signals are recorded is formed of four or eight layers. Since the recording layer of the multilayer disk is separated by an intermediate layer, the thickness between the surface of the optical disk and the recording layer, that is, the thickness of a base material is considerably changed due to a layer on which recording or reproduction is performed. Spherical aberration is generated due to the change of the thickness of a base material.

FIG. 28 is a view showing a part of an optical system of an optical pickup device in the related art. Laser light entering an objective lens 104 is converted into converging light or diverging light by the movement of the collimator lens 100, so that it may be possible to correct the spherical aberration. Laser light passes through a collimator lens 100, passes through a rising mirror 101, and is reflected in a substantially vertical direction by a rising mirror 102. After that, the laser light passes through an achromatic diffraction lens 103, and is condensed to an optical disk 105 by an objective lens 104. However, when laser light passes through the rising mirror 101, astigmatism is generated.

The generation of astigmatism occurs for the following reason. FIG. 29 is a view, showing the optical path length of light passing through a flat plate such as an inclined rising mirror 101, for the description of astigmatism. FIG. 29A is a view showing an optical path length of light that is viewed in an X-axis direction, and FIG. 29B is a view showing an optical path length of light that is viewed in a Y-axis direction. As shown in FIGS. 29A and 29B, the optical path length in the yz plane of the flat plate is longer than the optical path length in the xz plane of the flat plate. Astigmatism is generated due to a difference between the optical path length in the yz plane and the optical path length in the xz plane.

As shown in FIG. 28, even in the case of the optical pickup device in the related art, likewise, the rising mirror 101 is formed of a flat plate and is inclined. Accordingly, as described with reference to FIG. 29, a difference is generated in the optical path length of light in the radial and tangential directions. Meanwhile, a radial direction of the optical disk 105 is referred to as a radial direction, and a circumferential direction of the optical disk 105 is referred to as a tangential direction. Astigmatism is generated due to the differences in the optical path length of laser light in the radial direction and the optical path length of laser light in the tangential direction. In particular, for example, in the optical disk 105 including eight or more recording layers, the error of the thickness of a base material when recording or reproduction is performed on the optical disk 105 is increased. The degrees of convergence and divergence of light need to be increased by the increase of the moving distance of the collimator lens 100. As a result, the astigmatism, which is generated on the laser light passing through the inclined rising mirror 101, is increased, so that normal recording or reproduction cannot be performed on the multilayer optical disk 105.

In order to solve these problems, the following technique has been disclosed in the pickup device in the related art. FIG. 30 is a view showing a part of an optical system of an optical pickup device in the related art that includes a rising prism, and FIG. 31 is a view showing a liquid crystal device that corrects astigmatism of the optical pickup device shown in FIG. 30 in the related art.

In the optical pickup device in the related art shown in FIG. 30, laser light emitted from a light source 110 passes through a beam splitter 111 and spherical aberration is corrected by a collimator lens 112. After that, the laser light passes through an astigmatism correcting element 113, is reflected toward a quarter wavelength plate 115 and an objective lens 116 by a rising prism 114, and enters an optical disk 117. Laser light reflected from the optical disk 117 passes through the objective lens 116 and the quarter wavelength plate 115, enters the rising prism 114, is reflected toward the astigmatism correcting element 113 and the collimator lens 112 by the rising prism 114, and enters the beam splitter 111. Since the beam splitter 111 can substantially reflect perpendicularly only the light reflected from the optical disk 117, laser light is reflected toward a lens 118 and is condensed to a signal detection system 119 by the lens 118. If the rising prism 114 is used as described above, astigmatism is generated like when laser light for a BD passes through a rising mirror. In this case, astigmatism is corrected by the control of the astigmatism correcting element 113 formed of, for example, a liquid crystal device (JP-A-2007-188588).

As for the liquid crystal device, there has been a technique for dividing a transparent electrode 210 of a liquid crystal panel into nine pattern electrodes 200 to 208 as shown in FIG. 31. A circular pattern electrode 200 is formed at a central portion of an incidence range 209 of a light beam corresponding to a pupil of an objective lens. Pattern electrodes 201 to 208, which are radially divided and have shapes similar to each other, are formed at the peripheral portion of the circular pattern electrode. Driving patterns and driving voltages applied to the pattern electrodes 201 to 208, which are formed at the peripheral portion, are appropriately controlled so as to correspond to the directionality of astigmatism caused by an optical system, and astigmatism is corrected by making the light beam pass through the electrodes in this state and applying phase differences, which are based on the difference in refractive index (JP-A-2000-040249). However, according to the above-mentioned structure, even though it may be possible to correct astigmatism in the polarization direction of the laser light directed to the optical disk, it may not be possible to correct astigmatism of the light reflected from the optical disk of which the polarization direction is changed to a right angle. That is, a wavelength plate, which rotates the polarization direction of short-wavelength laser light passing two times (on a going path and a return path) by about 90°, is provided on the achromatic diffraction lens 103 shown in FIG. 28. Since liquid crystal has polarization dependency, it may not be possible to control astigmatism of the light which is reflected from the optical disk and of which the polarization direction is changed. In addition, a system, which is used to control power consumption and the liquid crystal device, is required in order to drive the liquid crystal device.

Accordingly, the invention has been made in consideration of the above-mentioned problem, and an object of the invention is to provide an optical pickup device capable of correcting the astigmatism of not only laser light directed to the optical disk but also light reflected from the optical disk of which the polarization direction is different by about 90° from that of the laser light directed to the optical disk, without requiring power or a specific system when astigmatism generated by the rising prism, the rising mirror, or the like is corrected.

### SUMMARY

In order to achieve the object, an optical pickup device according to the invention includes a light source, a movable condensing lens, a rising prism or a rising mirror, an objective lens, and a phase plate. The light source emits laser light, and the movable condensing lens converts the laser light into converging light or diverging light. The rising prism or the rising mirror converts an optical axis of laser light passing through the condensing lens into a substantially vertical direction. The objective lens condenses the laser light, of which the optical axis is converted by the rising prism or the rising mirror, to an optical disk. The phase plate is provided between the condensing lens and the objective lens, and includes stepped portions that are formed at portions facing each other and have different thicknesses. The phase plate corrects astigmatism, which is generated by the rising prism or the rising mirror, by making a part of laser light having a size larger than a predetermined size pass through the stepped portions of the phase plate.

Another object of the invention is to make a significant change of the diameter of laser light that is caused by the change of the thickness of a base material between a collimator lens and a rising mirror, and to correct astigmatism more accurately by disposing a phase plate between the collimator lens and the rising mirror.

Another object of the invention is to correct astigmatism by offsetting the differences in the optical path lengths in the tangential and radial directions, which are generated by laser light causing astigmatism that passes through a rising mirror, by the difference in the optical path length that is generated by the laser light passing through a phase plate, since the optical path length of laser light, which passes through phase steps, of laser light passing through the phase plate is different from that of laser light that does not pass through the phase steps if a part of laser light, which has a size larger than a predetermined size so as to be significantly affected by astigmatism, passes through the phase steps.

Another object of the invention is to correct astigmatism by offsetting the differences in the optical path lengths in the tangential and radial directions by the difference in the optical path length that is generated by the laser light passing through a phase plate, since a phase step is thicker than a central portion and the optical path length of laser light, which passes through phase steps, of laser light passing through the phase plate is thus different from that of laser light that does not pass through the phase steps.

Another object of the invention is to correct astigmatism by offsetting the differences in the optical path lengths in the tangential and radial directions by the difference in the optical path length that is generated by the laser light passing through a phase plate, since a phase step is thinner than a central portion and the optical path length of laser light, which passes through phase steps, of laser light passing through the phase plate is thus different from that of laser light that does not pass through the phase steps.

Another object of the invention is to stabilize the accuracy of the correction of astigmatism without changing the area of laser light passing through steps formed at a phase plate even when laser light is moved in the radial direction by, for example, tracking control or the like.

Another object of the invention is apt to suppress astigmatism since a ratio of laser light passing through steps provided at a phase plate is smaller than that of laser light passing through a portion within the steps and the ratio of laser light of which the optical path length is changed is thus increased.

Another object of the invention is to correct astigmatism more accurately by stepwise changing the diameter of laser light entering a phase plate for the thickness of a base material of a plurality of recording surfaces of an optical disk and providing a plurality of phase steps in the shape of steps.

Another object of the invention is to further reduce the size of an optical pickup device by forming a phase plate with only portions capable of causing the difference in the optical path length of a part of the laser light that passes through stepped portions, which have different thicknesses, of a phase plate and causes the change in the optical path length and in the optical path length of a part of the laser light that does not pass through the stepped portions having different thicknesses and does not cause the change in the optical path length.

Another object of the invention is to further reduce the size of an optical pickup device by forming a phase plate with only portions capable of causing the difference in the optical path length of a part of the laser light that passes through stepped portions, which have different thicknesses, of a phase plate and causes the change in the optical path length and in the optical path length of a part of the laser light that does not pass through the stepped portions having different thicknesses and does not cause the change in the optical path length.

Another object of the invention is to correct astigmatism by forming phase steps and a central portion of a phase plate with different materials that are base body and bonding members, and to control the optical path length of laser light, make a phase plate thin, and accurately correct astigmatism since the degree of freedom of design is increased by forming a phase plate having the combination of various materials or various shapes.

Another object of the invention is to form a phase plate easily and design the phase plate easily by simplifying the structure of the phase plate.

Another object of the invention is to form a phase plate easily by using steps, which are formed between thick and thin portions of a base body, as the reference for the mounting of bonding member.

Another object of the invention is to control easily the optical path length of laser passing through a phase modulating portion by increasing the degree of freedom of design.

Another object of the invention is to form a phase plate easily by a simple process for coating films on a base body and to control easily the thickness of a phase modulating portion or a central portion.

Another object of the invention is to correct astigmatism by offsetting the differences in the optical path lengths in the tangential and radial directions, which are generated by laser light that is emitted from a short-wavelength optical unit and passes through a rising mirror, by the difference in the optical path length that is generated by laser light passing through a phase plate. Further, since the phase plate does not have polarization dependency unlike liquid crystal, it may be possible to correct the astigmatism of not only laser light directed to an optical disk but also light reflected from the optical disk of which the polarization direction is different from that of the laser light directed to the optical disk. Accordingly, information is correctly recorded in or reproduced from a multilayer optical disk without redundancy. In addition, since the phase plate made of glass or the like has been simply provided, astigmatism is corrected at low cost without power or a specific system.

### BRIEF DESCRIPTION OF THE DRAWINGS

FIG. 1 is a schematic view showing the structure of an optical pickup device according to a first embodiment of the invention,

FIG. 2 is a plan view of an example of an optical structure of the optical pickup device according to the first embodiment of the invention.

FIG. 3A is a plan view of a quadrangular phase plate of the first embodiment of the invention including phase steps that are linear thick stepped portions formed at two sides of the phase plate facing each other in a tangential direction.

FIG. 3B is a side view of the phase plate shown in FIG. 3A.

FIG. 3C is a plan view of a phase plate of the first embodiment including phase steps that are linear thick stepped portions formed at two sides of the phase plate facing each other in a radial direction.

FIG. 4A is a plan view of a phase plate of the first embodiment that includes linear thin phase steps.

FIG. 4B is a side view of the phase plate shown in FIG. 4A.

FIG. 5A is a plan view of a phase plate of the first embodiment of the invention including phase steps that are partially formed in a substantially circular arc shape corresponding to the shape of laser light.

FIG. 5B is a side view of the phase plate shown in FIG. 5A.

FIG. 6A is a plan view of a phase plate of the first embodiment of the invention including a plurality of phase steps so that the cross-section of the phase plate stepwise becomes thick toward the end portions of the phase plate.

FIG. 6B is a side view of the phase plate shown in FIG. 6A.

FIG. 7 is a graph showing a relationship between astigmatism and the thickness of a base material of an optical disk when an optical pickup device is provided with the phase plate shown in FIG. 3A.

FIG. 8A is a view showing a part of an optical system when the phase plate of the first embodiment of the invention is provided between a collimator lens and a rising mirror.

FIG. 8B is a view showing a part of an optical system when the phase plate of the first embodiment of the invention is provided between two rising mirrors.

FIG. 8C is a view showing a part of an optical system when the phase plate of the first embodiment of the invention is provided between a rising mirror and an objective lens.

FIG. 9A is a plan view of a phase plate of a second embodiment of the invention formed of only phase steps that are two stepped portion.

FIG. 9B is a side view of the phase plate shown in FIG. 9A.

FIG. 9C is a perspective view showing that the phase plate shown in

FIG. 9A is mounted on bases.

FIG. 10A is a plan view of a phase plate of which portions corresponding to phase steps are cut and which is formed of only a central portion so that the thickness of a stepped portion is zero.

FIG. 10B is a side view of the phase plate shown in FIG. 10A.

FIG. 11A is a plan view of a phase plate of a third embodiment of the invention of which phase steps are formed by laminating bonding members on two sides of a flat base body facing each other in a tangential direction.

FIG. 11B is a side view of the phase plate shown in FIG. 11A.

FIG. 12 is a plan view of a phase plate of the third embodiment of the invention of which phase steps are formed by laminating bonding members on two sides of a flat base body facing each other in a radial direction.

FIG. 13A is a plan view of a phase plate of the third embodiment of the invention of which a central portion is formed by laminating a bonding member on a center portion of the flat base body.

FIG. 13B is a side view of the phase plate shown in FIG. 13A.

FIG. 14A is a plan view of a phase plate of which phase steps are formed by laminating bonding members on thin portions of a base body formed at sides facing each other.

FIG. 14B is a side view of the phase plate shown in FIG. 14A.

FIG. 15A is a plan view of a phase plate of which a central portion is formed by laminating a bonding member on a thin portion of a base body.

FIG. 15B is a side view of the phase plate shown in FIG. 15A.

FIG. 16A is a plan view of a phase plate of the third embodiment of the invention of which phase steps are formed by laminating materials having a plurality of different refractive indexes in a thickness direction of the phase plate.

FIG. 16B is a side view of the phase plate shown in FIG. 16A.

FIG. 17A is a plan view of a phase plate of the third embodiment of the invention of which a central portion is formed by laminating materials having a plurality of different refractive indexes in a thickness direction of the phase plate.

FIG. 17B is a side view of the phase plate shown in FIG. 17A.

FIG. 18A is a plan view of a phase plate of the third embodiment of the invention of which phase steps are formed by laminating materials having a plurality of different refractive indexes in a direction from the center toward the outer end portions of the phase plate so that the refractive index of the phase plate is increased or decreased toward end portions of the phase plate.

FIG. 18B is a side view of the phase plate shown in FIG. 18A.

FIG. 19A is a plan view of a phase plate of the third embodiment of the invention of which phase steps are formed so that the cross-sections of the phase steps stepwise become thick or thin toward the end portions of the phase plate.

FIG. 19B is a side view of the phase plate shown in FIG. 19A when bonding members becoming thick toward the end portions of a flat base body are laminated.

FIG. 19C is a side view of the phase plate shown in FIG. 19A when bonding members becoming thin toward the end portions are laminated on a base body of which two sides facing each other are formed to be thin.

FIG. 20A is a plan view of a phase plate of the third embodiment of the invention of which phase steps are formed by laminating materials having a plurality of different refractive indexes in a thickness direction of the phase plate or in a direction from the center toward the outer end portions of the phase plate so that the cross-sections of the phase steps stepwise become thick or thin toward the end portions of the phase plate.

FIG. 20B is a side view of the phase plate shown in FIG. 20A of which phase steps are formed by laminating bonding members in a thickness direction of the phase plate so as to become thick toward the end portions of a flat base body.

FIG. 20C is a side view of the phase plate shown in FIG. 20A of which phase steps are formed by laminating bonding members in a direction from the center of the phase plate toward the outer end portions of the phase plate so as to become thin toward the end portions of the base body of which two sides facing each other are formed to be thin.

FIG. 21A is a plan view of a phase plate of the third embodiment of the invention of which a central portion is formed by laminating a bonding member on a center portion of a base body and phase steps are formed so that the cross-sections of portions of the base material facing each other stepwise become thick or thin toward the end portions of the phase plate.

FIG. 21B is a side view of the phase plate shown in FIG. 21A of which a central portion is formed by laminating a bonding member on a flat base body of which phase steps are formed so as to become thin toward the end portion.

FIG. 21C is a side view of the phase plate shown in FIG. 21A of which a central portion is formed by laminating a bonding member on a thin portion of a base body and the cross-sections of sides of the base body facing each other stepwise become thick toward the end portions of the phase plate.

FIG. 22A is a plan view of a phase plate of a fifth embodiment of the invention where phase steps are connected to the outer surfaces of a central portion facing each other.

FIG. 22B is a side view of the phase plate shown in FIG. 22A.

FIG. 23A is a plan view of a phase plate of the fifth embodiment of the invention of which phase steps are formed by laminating materials having a plurality of different refractive indexes in a direction from the center of the phase plate toward the outer end portions of the phase plate so that the refractive index of the phase plate is increased or decreased toward end portions of the phase plate.

FIG. 23B is a side view of the phase plate shown in FIG. 23A.

FIG. 24A is a plan view of a phase plate of which phase steps are formed by laminating materials having a plurality of different refractive indexes in a thickness direction.

FIG. 24B is a side view of the phase plate shown in FIG. 24A.

FIG. 25A is a plan view of a phase plate of the fifth embodiment of the invention of which phase steps are formed so that the cross-sections of the phase steps stepwise become thick or thin toward the end portions of the phase plate.

FIG. 25B is a side view of the phase plate shown in FIG. 25A of which phase steps are formed so as to become thin toward the end portions of the phase plate.

FIG. 25C is a side view of the phase plate shown in FIG. 25A of which phase steps are formed so as to become thick toward the end portions of the phase plate.

FIG. 26A is a plan view of a phase plate of the fifth embodiment of the invention of which phase steps are formed by laminating materials having a plurality of different refractive indexes in a thickness direction of the phase plate or in a direction from the center toward the outer end portions of the phase plate so that the cross-sections of the phase steps stepwise become thick or thin toward the end portions of the phase plate.

FIG. 26B is a side view of the phase plate shown in FIG. 26A of which phase steps are laminated in a direction from the center of the phase plate toward the outer end portions of the phase plate so as to become thin toward the end portions of the phase plate facing each other.

FIG. 26C is a side view of the phase plate shown in FIG. 26A of which phase steps are formed by laminating bonding members in a thickness direction of the phase plate so as to become thick toward the end portions of the phase plate.

FIG. 27 is a perspective view of an optical disk apparatus according to a sixth embodiment of the invention that uses the optical pickup device described in the first to fifth embodiments.

FIG. 28 is a view showing a part of an optical system of an optical pickup device in the related art.

FIG. 29A is a view that illustrates astigmatism and shows an optical path length of light when light passing through an inclined flat plate is viewed in an X-axis direction.

FIG. 29B is a view that illustrates astigmatism and shows an optical path length of light when light passing through an inclined flat plate is viewed in a Y-axis direction.

FIG. 30 is a view showing a part of an optical system of an optical pickup device in the related art that includes a rising prism.

FIG. 31 is a view showing a liquid crystal device that corrects astigmatism of the optical pickup device shown in FIG. 30 in the related art.

### DETAILED DESCRIPTION

Embodiments of the invention will be described below with reference to the drawings.

First Embodiment

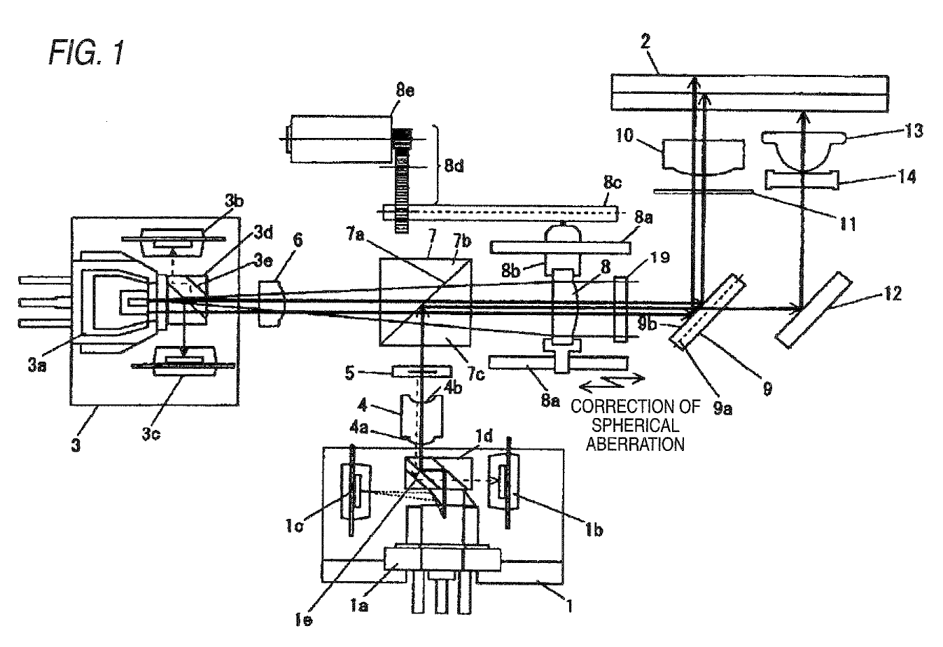

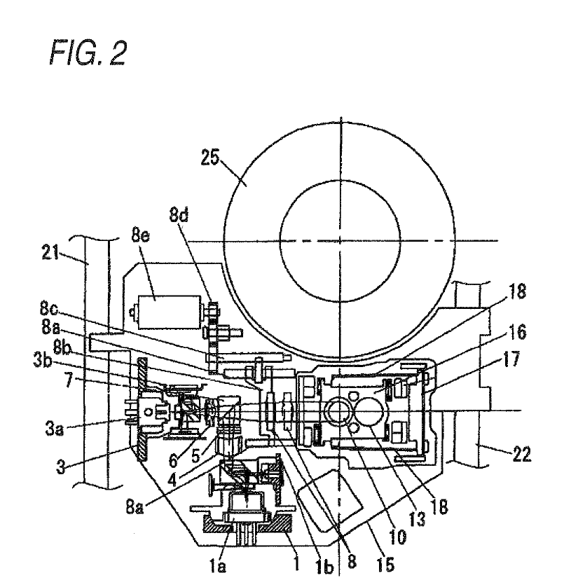

FIG. 1 is a schematic view showing the structure of an optical pickup device according to a first embodiment. Meanwhile, a radial direction of an optical disk 2 is referred to as a radial direction, and a circumferential direction of the surface of the optical disk is referred to as a tangential direction. FIG. 2 is a plan view of an actual example of an optical structure of the optical pickup device shown in FIG. 1. The components shown in FIG. 2 have shapes somewhat different from those of the components shown in FIG. 1, but have substantially the same functions as those of the components shown in FIG. 1.

Reference numeral 1 denotes a short-wavelength optical unit that emits short-wavelength laser. Laser light emitted from the short-wavelength optical unit 1 has a wavelength in the range of 400 to 415 nm, and the short-wavelength optical unit is formed to emit light having a wavelength of about 405 nm in the first embodiment. In the first embodiment, the short-wavelength optical unit includes a light source part I a that emits short-wavelength laser light, a light receiving part 1b for signal detection that receives laser light reflected from the optical disk 2, a light receiving part 1c that is provided so as to monitor the amount of the laser light emitted from the light source part 1a, an optical member 1d, and a holding member (not shown) that holds these components with a predetermined positional relationship. A semiconductor laser element (not shown) of which a principal ingredient is GaN or GaN is provided in the light source part 1a. Laser light emitted from the semiconductor laser element enters the optical member 1d, and a part of the entering laser light is reflected by the optical member 1d and enters the light receiving part 1c for monitoring. Although not shown, there is provided a circuit or the like that converts the laser light into an electric signal by the light receiving part 1c for monitoring and adjusts the intensity of the laser light emitted from the light source part 1a to a desired intensity on the basis of the electric signal. The light receiving part 1b for signal detection converts a laser light into an electric signal, and generates an RF signal, a tracking error signal, a focus error signal, and the like from the electric signal. A hologram 1e, which separates light reflected from the optical disk 2 so as to obtain the focus error signal, is provided on the optical member 1d.

Reference numeral 3 denotes a long-wavelength optical unit that emits long-wavelength laser. Laser light emitted from the long-wavelength optical unit 3 has a wavelength in the range of 640 to 800 nm, and the long-wavelength optical unit is formed so as to emit a single beam of laser light having one wavelength, or so as to emit a plurality of beams of laser light having several wavelengths. In the first embodiment, the long-wavelength optical unit is formed so as to emit a light flux having a wavelength of about 660 nm (red: for example, which corresponds to a DVD) and a light flux having a wavelength of about 780 nm (infrared: for example, which corresponds to a CD). In the first embodiment, the long-wavelength optical unit includes a light source part 3a that emits long-wavelength laser light, a light receiving part 3b for signal detection that receives laser fight reflected from the optical disk 2, a light receiving part 3c that is provided so as to monitor the amount of the laser light emitted from the light source part 3a, an optical member 3d, and a holding member (not shown) that holds these components with a predetermined positional relationship. A semiconductor laser element (not shown) is provided in the light source part 3a. The semiconductor laser element is formed of a monoblock (monolithic structure), and a light flux (red) having a wavelength of about 660 nm and a light flux (infrared) having a wavelength of about 780 nm are emitted from the monoblock element. Meanwhile, in the first embodiment, two light fluxes have been emitted from the monoblock element. However, the light source part may include two block elements each of which emits one light flux. A plurality of light fluxes emitted from the semiconductor laser element enters the optical member 3d, and a part of the entering laser light is reflected by the optical member 3d and enters the fight receiving part 3c for monitoring. The light receiving part 3b for signal detection converts the laser light into an electric signal, and generates an RE signal, a tracking error signal, a focus error signal, and the like from the electric signal. Meanwhile, a hologram 3e, which separates light reflected from the optical disk 2 into a plurality of beams of light in order to generate a focus error signal for a CD and guides the beams of light to the respective predetermined positions on the light receiving part 3b for signal detection, is provided on the optical member 3d.

Reference numeral 4 denotes a beam shaping lens through which the light emitted from the short-wavelength optical unit 1 and the light reflected from the optical disk 2 pass. The beam shaping lens 4 is provided to increase the use efficiency of the light emitted from the long-wavelength optical unit, and to cancel the astigmatism of short-wavelength laser light and astigmatism that is generated on an optical path between the short-wavelength optical unit 1 and the optical disk 2. Further, a convex portion 4a and a concave portion 4b are formed on both ends of the beam shaping lens 4, and the beam shaping lens 4 is disposed so that the light emitted from the short-wavelength optical unit 1 enters the convex portion 4a first and is then emitted from the concave portion 4b.

Reference numeral 5 denotes an optical component. The optical component 5 is disposed on the front side of the beam shaping lens 4 on the optical path, and is disposed so as to face the concave portion 4b of the beam shaping lens 4. That is, the laser light emitted from the short-wavelength optical unit 1 enters the optical component 5 through the beam shaping lens 4, and is guided to the optical disk 2. The laser light reflected from the optical disk 2 enters the short-wavelength optical unit 1 via the optical component 5 and the beam shaping lens 4 in that order. A hologram or the like is provided on the optical component 5, and separates laser light reflected from the optical disk 2 into predetermined light fluxes so as mainly to generate a tracking error signal.

Reference numeral 6 denotes a relay lens through which the long-wavelength laser light emitted from the long-wavelength optical unit 3 passes. The relay lens 6 is made of a transparent material, such as a resin or glass. The relay lens 6 is provided so as efficiently to guide the light, which is emitted from the long-wavelength optical unit 3, to a member provided on the rear side.

Reference numeral 7 denotes a beam splitter that is an optical member. The beam splitter 7 includes at least two transparent members 7b and 7c that are bonded to each other. An inclined surface 7a, on which one wavelength selective film is provided, is provided between the transparent members 7b and 7c. A wavelength selective film is directly formed on the inclined surface 7a of the transparent member 7c where the laser light emitted from the short-wavelength optical unit 1 enters. A transparent member 7b is bonded to the inclined surface 7a of the transparent member 7c, on which the wavelength selective film is formed, through a bonding member, such as a resin or glass.

Reference numeral 8 denotes a collimator lens that is movably held. Laser light is converted from diverging light into parallel light by passing through the collimator lens 8. The collimator lens 8 is mounted on a slider 8b, and the slider 8b is movably mounted on a pair of support members 8a that is provided substantially parallel to each other. A lead screw 8c on which a helical groove is formed is provided substantially parallel to the support members 8a. A protrusion, which is fitted to the groove of the lead screw 8c, is provided at the end portion of the slider 8b. A gear group 8d is fixed to the lead screw 8c, and a driving member 8e formed of a stepping motor is connected to the gear group 8d. A driving force of the driving member Be is transmitted to the lead screw 8c through the gear group 8d, and the lead screw 8c is rotated by the driving force. As a result, the slider 8b is moved along the support members 8a. It may be possible to adjust the spherical aberration easily by employing the structure that makes the collimator lens 8 approach or be separated from the beam splitter 7 as described above. In the first embodiment, the structure that moves the collimator lens 8 by the driving member 8e has been employed as a structure that corrects the spherical aberration of the short-wavelength laser light. The collimator lens 8 may be moved by another structure, and the spherical aberration of the short-wavelength laser light may be adjusted by other means.

Reference numeral 9 denotes a rising mirror. The rising mirror 9 is provided with a quarter wavelength member 9a that acts on short-wavelength laser light. A quarter wavelength plate, which rotates the polarization direction of laser light passing two times (on a going path and a return path) by about 90°, is preferably used as the quarter wavelength member 9a. A wavelength selective film 9b is provided on the surface of the rising mirror 9 where the light emitted from each of the units 1 and 3 enters. Accordingly, the rising mirror has a function to reflect most of the long-wavelength laser light emitted from the long-wavelength optical unit 3 and a function to transmit most of the short-wavelength laser light emitted from the short-wavelength optical unit 1.

Reference numeral 10 denotes an objective lens for long-wavelength laser. The objective lens 10 condenses the laser light, which is reflected from the rising mirror 9, to the optical disk 2. The objective lens 10 has been used in the first embodiment, but other condensing members such as a hologram may be used.

Reference numeral 11 denotes an optical component that is provided between the objective lens 10 and the rising mirror 9. The optical component 11 includes an aperture filter that makes a necessary numerical aperture so as to correspond to an optical disk 2 such as a DVD (which corresponds to light having a wavelength of about 660 nm) and a CD (which corresponds to light having a wavelength of about 780 nm), a polarization hologram that reacts to laser light having a wavelength of about 660 nm, and a quarter wavelength member (preferably, a quarter wavelength plate). The optical component 11 is formed of a dielectric multilayer film, diffraction grating opening means, or the like. The polarization hologram deflects light having a wavelength of about 660 nm (separates light having a wavelength of about 660 nm into light for a tracking error signal or a focus error signal).

Reference numeral 12 denotes a rising mirror that reflects most of short-wavelength laser light. A reflective film is provided on the rising mirror 12.

Reference numeral 13 denotes an objective lens. The objective lens 13 condenses laser light, which is reflected from the rising mirror 12, to the optical disk 2. The objective lens 13 has been used in the first embodiment, but other condensing members such as a hologram may be used. The objective lens 13 is made of glass or a resin. However, when the objective lens 13 is made of a resin, the objective lens is preferably made of a resin resistant to short-wavelength light (a resin that is hardly deteriorated by short-wavelength light).

Reference numeral 14 denotes an achromatic diffraction lens that is provided between the objective lens 13 and the rising mirror 12. The achromatic diffraction lens 14 has a function to correct chromatic aberration. The achromatic lens 14 is provided with a quarter wavelength member that acts on short-wavelength light. A quarter wavelength plate, which rotates the polarization direction of light passing two times (on a going path and a return path) by about 90°, is preferably used as the quarter wavelength member. The achromatic diffraction lens 14 is provided so as to cancel and reduce chromatic aberration generated at the respective optical components through which short-wavelength laser light passes.

Reference numeral 15 denotes a base. The above-mentioned respective members are fixed to or movably mounted on the base 15. The short-wavelength optical unit 1 that emits and receives short-wavelength laser light, the long-wavelength optical unit 3 that emits and receives long-wavelength laser light, and a lens holder 16 as a lens holding part on which the objective lenses 10 and 13 are mounted are mounted on the base 15. The base is movably mounted on shafts 21 and 22. The base 15 is made of metal or a metal alloy, such as zinc, a zinc alloy, aluminum, an aluminum alloy, magnesium, or a magnesium alloy. In terms of mass production, the base is preferably formed by die-casting.

Reference numeral 17 denotes a suspension holder. The suspension holder 17 is mounted on the base 15 by various bonding methods. The lens holder 16 and the suspension holder 17 are fixed to each other through a plurality of suspensions 18. The lens holder 16 is supported so as to be moved with respect to the base 15 in a predetermined range. The objective lenses 10 and 13, the optical component 11, the achromatic diffraction lens 14 (see FIG. 1), and the like are mounted on the lens holder 16. The objective lenses 10 and 13, the optical component 11, and the achromatic diffraction lens 14 are also moved together with the lens holder 16 by the movement of the lens holder 16. Reference numeral 19 denotes a phase plate that includes stepped portions. The phase plate corrects astigmatism. The phase plate 19 will be described in detail below. Reference numerals 21 and 22 denote shafts that move the base 15 in the radial direction. Reference numeral 25 denotes a spindle motor on which the optical disk 2 is placed.

The phase plate 19, which is a feature point of the invention, will be described in detail below.

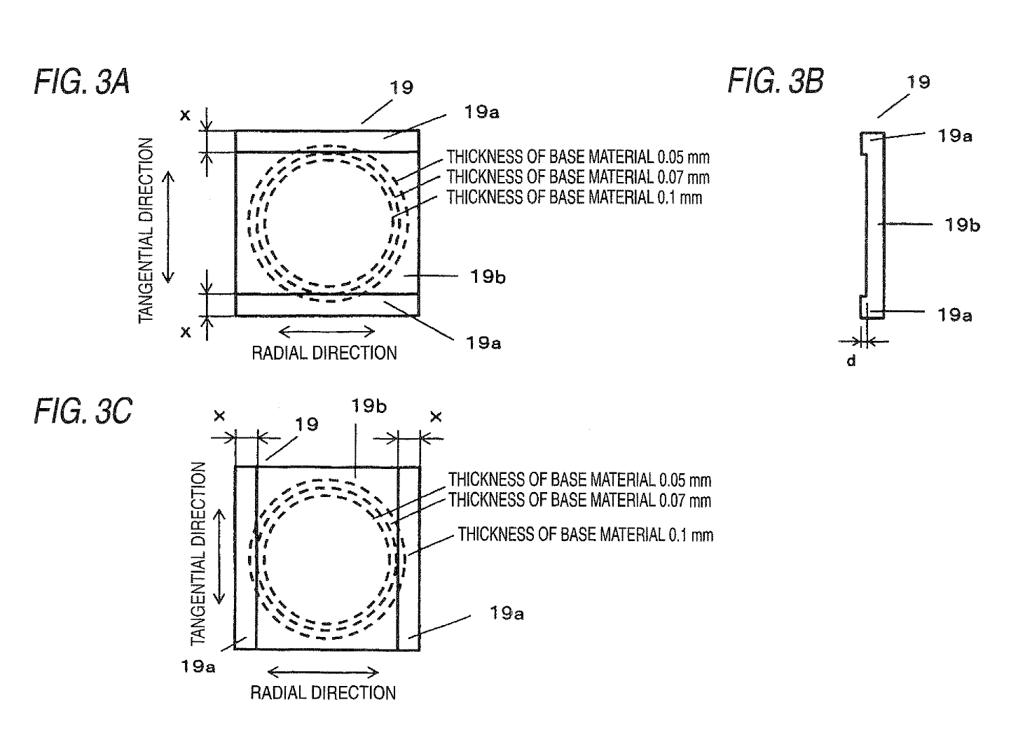

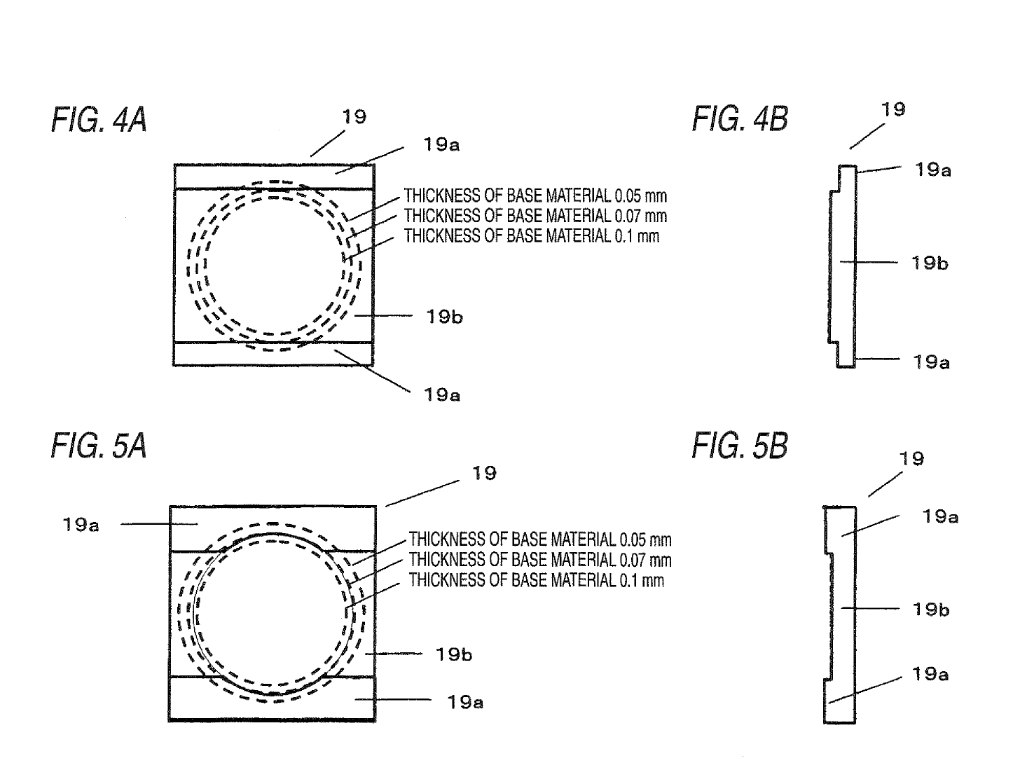

The phase plate 19 is provided between the collimator lens 8 and the objective lens 13 so as to be substantially perpendicular to laser light. Meanwhile, the phase plate 19 may be inclined with respect to laser light by about 4° in order to avoid the influence of stray light. Examples of a material of the phase plate 19 include a transparent resin material such as acrylic, white sheet glass or optical glass such as BK7. The phase plate 19 includes phase steps 19a as stepped portions that are provided at two sides of the phase plate facing each other in a tangential direction as shown in FIG. 3A or at two sides of the phase plate facing each other in a radial direction as shown in FIG. 3C, and a central portion 19b that is provided between two phase steps 19a, Only portions where the phase steps 19a are provided are formed to be thick as shown in FIGS. 3A to 3C or to be thin as shown in FIGS. 4A and 4B. For example, it may be possible to form the phase steps 19a easily by etching the phase plate 19 that is formed of a glass substrate or the like. Further, it may also be possible to form the phase steps by the molding of glass or a resin. Meanwhile, if a wavelength of light becomes 420 nm or less when a resin is used as a material of the phase step 19a, chemical change is apt to occur. Accordingly, it is preferable that optical absorptance be 5% or less, and it is more preferable that optical absorptance be 3% or less. Further, it is preferable that for example amorphous polyolefin (ZEONEX, APEL, or the like) be used as a material of the phase step.

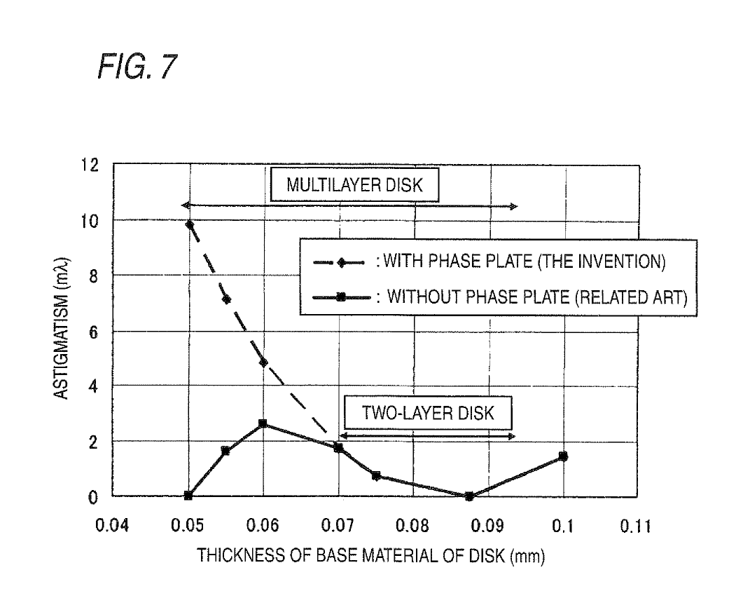

As described above, the thickness of a base material of a recording layer of the multilayer optical disk 2 is significantly changed by each recording layer, and spherical aberration is generated due to the change. In order to correct the spherical aberration, laser light is converted into converging light or diverging light by the movement of the collimator lens 8. If the thickness of the base material is small, the laser light is increased by moving the collimator lens 8. Further, it is understood that the influence of astigmatism is increased in the optical pickup device in the related art as shown in FIG. 7 as the thickness of a base material of the recording layer is decreased. That is, as the thickness of a base material of the recording layer is decreased, the diameter of laser light is increased and the influence of astigmatism is increased.

In the optical pickup device according to the first embodiment, a part of laser light, of which the diameter is equal to or larger than a predetermined size so that the influence of astigmatism is increased, passes through the phase steps 19a. Since the phase step 19a is thicker or thinner than the central portion 19b, the optical path length of the laser light, which passes through the phase steps 19a, of the laser light, which passes through the phase plate 19, is different from that of laser light that does not pass through the phase steps 19a. That is, assuming that the refractive index of the phase plate 19 is represented by n, the refractive index of air is 1, and the thickness of the phase step 19a is represented by d, the optical path length of the laser light passing though the phase step 19a is represented by do and the optical path length of the laser light, which does not pass though the phase step 19a and passes through air by the same thickness as the thickness of the phase step 19a, is represented by d. Accordingly, a difference d(n−1) is generated in the optical path lengths of the laser light passing through the phase step 19a and the laser light not passing through the phase step 19a. Accordingly, it may be possible to offset the differences in the optical path lengths in the tangential and radial directions, which are generated by the laser light causing astigmatism that passes through the rising mirror 9, by the difference d(n−1) in the optical path length in one direction of the tangential and radial directions that is generated by the laser light passing through the phase plate 19. Meanwhile, assuming that the wavelength of light is represented by λ and the phase difference of the laser light passing through the phase step 19a is represented by Δ, the thickness d of the phase step 19a is represented by Δλ/(n−1). Δλ represents the difference in the optical path length of the laser light that passes through the phase step 19a. Further, in the first embodiment, the wavelength λ of light of a BD is 405 nm, a material of the phase plate 19 is optical glass BK7 having a refractive index n of 1.53, the phase difference Δ is 0.07λ, and the thickness d of the phase step is 53 nm. Meanwhile, even though the phase difference Δ is 1.07λ, and the thickness d of the phase step is 820 nm, it may be possible to obtain the same effect. Furthermore, only the phase steps 19a of the phase plate 19 may be formed to be thin. For example, even though the phase difference Δ is −0.932λ, and the thickness d of the phase step 19a is −710 nm, it may be possible to obtain the same effect.

Since linear thick phase steps 19a are provided at two sides, which face each other, of phase plates 19 shown in FIGS. 3A to 3C, the cross-sections of portions where the phase steps 19a are provided become thick. The linear thick phase steps 19a are provided at two sides, which face each other in the tangential direction, of the phase plate 19 shown in FIG. 3A. The linear thick phase steps 19a are provided at two sides, which face each other in the radial direction, of the phase plate 19 shown in FIG. 3C. Further, the thickness of a base material of the largest optical disk where a part of the laser light passes through the phase step 19a is set to 0.07 mm, and the width x of the phase step 19a is set so that the laser light does not pass through the phase step 19a if the thickness of a base material is 0.07 mm or more. Accordingly, the magnitude of astigmatism on a recording layer of the optical disk, where the thickness of a base material is in the range of 0.07 to 0.1 mm as shown in FIG. 4, is the same as that in the case of an optical pickup device in the related art and it may be possible to suppress the influence of astigmatism on the recording layer of which the thickness of a base material is 0.07 mm or less.

Since linear thin phase steps 19a are provided at two sides, which face each other, of the phase plate 19 shown in FIGS. 4A and 4B, the cross-sections of portions where the phase steps 19a are provided become thin. Like the phase plate shown in FIGS. 3A and 3B, the thickness of a base material of the largest optical disk 2 where a part of the laser light passes through the phase step 19a is set to 0.07 mm, and the width x of the phase step 19a is set so that the laser light does not pass through the phase step 19a if the thickness of a base material is 0.07 mm or more. Accordingly, the magnitude of astigmatism on a recording layer of the optical disk 2, where the thickness of a base material is in the range of 0.07 to 0.1 mm, is the same as that in the case of an optical pickup device in the related art and it may be possible to suppress the influence of astigmatism on the recording layer of which the thickness of a base material is 0.07 mm or less.

Further, since the phase steps 19a shown in FIGS. 3A, 3B, 4A, and 4B are formed in a linear shape, the area of the laser light passing through the phase step 19a is not changed even when laser light is moved in the radial direction by, for example, tracking control or the like. Accordingly, it may be possible to correct astigmatism without difficulty.

Phase steps 19a are provided at two sides, which face each other, of the phase plate 19 shown in FIGS. 5A and 5B. However, the phase steps 19a are partially formed in a substantially circular arc shape so as to correspond to the shape of laser light, so that the cross-sections of only the portions where the phase steps 19a are provided are different. Meanwhile, the cross-sections of the phase steps 19a are thick as shown in FIG. 5B, but may be formed to be thin. The phase steps 19a are formed at the phase plate 19 shown in FIG. 5A so as to correspond to the shape of laser light that performs recording and reproduction on a recording layer of which the thickness of a base material is 0.07 mm. Accordingly, like the phase plate 19 shown in FIGS. 3A, 3B, 4A, and 4B, the magnitude of astigmatism on a recording layer of the optical disk 2, where the thickness of a base material is in the range of 0.07 to 0.1 mm, is the same as that in the case of an optical pickup device in the related art and it may be possible to suppress the influence of astigmatism on the recording layer of which the thickness of a base material is 0.07 mm or less. In addition, if the phase steps 19a are formed in the above-mentioned shape, a ratio of laser light passing through the phase steps 19a, when recording or reproduction is performed on the recording layer of which the thickness of a base material is 0.07 mm or less, is higher than those in the cases of the phase plates 19 shown in FIGS. 3A, 3B, 4A, and 4B. Accordingly, a ratio of the laser light of which the optical path length is changed is increased, and astigmatism is apt to be suppressed.

Meanwhile, in the phase plate 19 shown in FIGS. 3 to 5, the thickness of a base material of the largest optical disk 2 where a part of the laser light passes through the phase step 19a has been set to 0.07 mm. However, the thickness of a base material of the largest optical disk may be set to 0.06 mm or 0.08 mm, and may be appropriately set to other values.

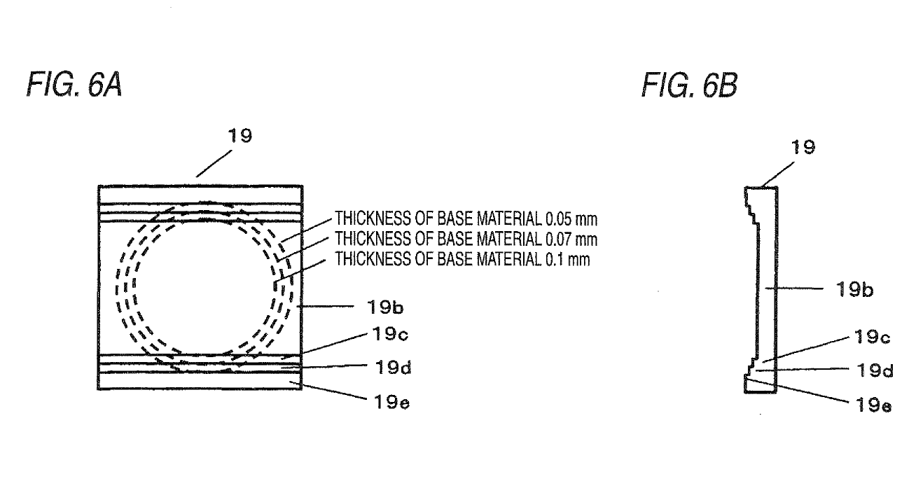

A plurality of phase steps 19c to 19e is provided at two sides, which face each other, of the phase plate 19 shown in FIGS. 6A and 6B. The cross-sections of the portions where the phase steps 19c to 19e are provided stepwise become thick toward the end portions of the phase plate. In FIG. 6A, the phase steps 19c to 19e are formed so that the thickness of a base material of the largest optical disk where a part of the laser light passes through the phase steps 19c is set to 0.1 mm, the thickness of a base material of the largest optical disk where a part of the laser light passes through the phase steps 19d is set to 0.07 mm, and the thickness of a base material of the largest optical disk where a part of the laser light passes through the phase steps 19e is set to 0.05 mm. Meanwhile, the cross-sections of portions of the phase plate 19 where the phase steps 19c to 19e are provided stepwise have become thin toward the end portions of the phase plate as shown in FIG. 6B, but may be formed to become thin toward the end portions. Further, the phase steps 19a of the phase plate 19 shown in FIG. 6A have been formed in a linear shape, but may be formed in a substantially circular arc shape corresponding to the shape of laser light.

It may be possible to correct astigmatism more accurately by forming the phase steps 19c to 19e as described above. In particular, since the diameter of the laser light entering the phase plate 19 is changed for the thickness of a base material of a plurality of recording surfaces of the optical disk, the phase steps 19c to 19e may be provided so as to correspond to the size of the laser fight as shown in FIG. 6A. Meanwhile, if the number of phase steps 19a to 19e is larger when a plurality of phase steps 19a is provided, it may be possible to correct astigmatism more accurately.

Meanwhile, each of the phase plates 19 shown in FIGS. 3 to 6 has been formed in a substantially quadrangular shape, but may be formed in other shapes, such as a polygonal shape and a circular shape. Accordingly, in the phase plate 19 shown in FIGS. 5A and 5b formed in the substantially quadrangular shape, the phase steps 19a have been partially formed in a substantially circular arc shape so as to correspond to the shape of laser light. In a phase plate 19 formed in a substantially circular shape, the entire phase steps 19a are formed in a substantially circular arc shape so as to correspond to the shape of laser light. Like in the phase plate 19 shown in FIG. 3, phase steps 19a may be formed at two sides, which face each other in the tangential direction, of the phase plates 19 shown in FIGS. 4 to 6, and phase steps 19a may be formed at two sides, which face each other in the radial direction, of the phase plates. The differences in the optical path lengths in the tangential and radial directions, which are generated by the laser light causing astigmatism that passes through the rising mirror 9, may be offset by the difference d(n−1) in the optical path length in the radial direction that is generated by the laser light passing through the phase plate 19. Meanwhile, since each of the phase plates 19 shown in FIGS. 3 to 6 has been formed in the quadrangular shape, the phase steps 19a have been provided at two sides facing each other. However, if the phase plate 19 is formed in other shapes such as a polygonal shape and a circular shape, the phase steps 19a may be provided at portions that face each other in the tangential or radial direction.

The optical system of the optical pickup device according to the first embodiment will be described in detail below.

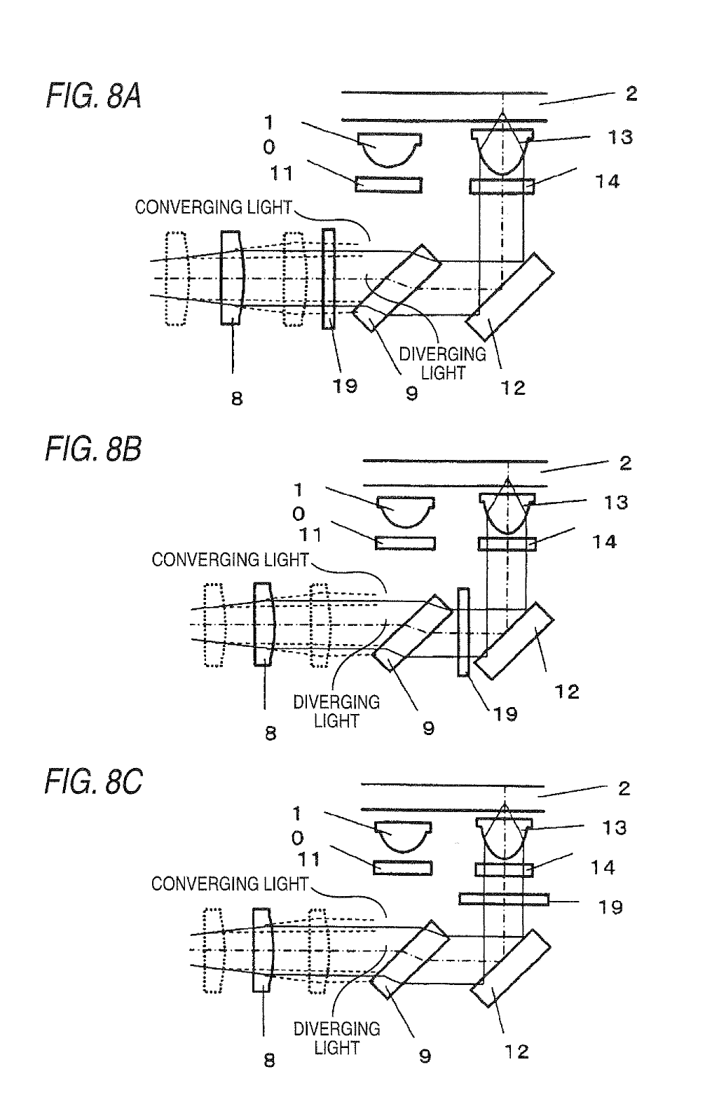

As shown in FIGS. 8A to 8C, laser light emitted from the short-wavelength optical unit is converted from diverging light into substantially parallel light by passing through the collimator lens 8, and the degree of convergence and divergence of laser light is controlled by the movement of the collimator lens 8.

If the phase plate 19 is provided between the collimator lens 8 and the rising mirror 9 as shown in FIG. 8A, laser light passing through the collimator lens 8 enters the phase plate 19, so that the optical path length of a part of the laser light is changed in the tangential direction. Then, the laser light enters the rising mirror 9. The rising mirror 9 transmits most of short-wavelength laser light. In this case, differences are generated in the optical path lengths in the tangential and radial directions. However, it may be possible to offset the differences in the optical path lengths in the tangential and radial directions, which are generated by the laser light passing through the rising mirror 9, by the difference d(n−1) in the optical path length in the tangential direction that is generated by the laser light passing through the phase plate 19. After that, the laser light is reflected by the rising mirror 12, passes through the achromatic diffraction lens 14, and enters the objective lens 13.

If the phase plate 19 is provided between two rising mirrors 9 and 12 as shown in FIG. 8B, laser light passing through the collimator lens 8 directly enters the rising mirror 9. The rising mirror 9 transmits most of short-wavelength laser light. In this case, differences are generated in the optical path lengths in the tangential and radial directions. After that, the laser light enters the phase plate 19, so that the optical path length of a part of the laser light is changed in the tangential direction. Accordingly, it may be possible to offset the differences in the optical path lengths in the tangential and radial directions, which are generated by the laser light passing through the rising mirror 9, by the difference d(n−1) in the optical path length in the tangential direction that is generated by the laser light passing through the phase plate 19. After that, the laser light is reflected by the rising mirror 12, passes through the achromatic diffraction lens 14, and enters the objective lens 13, if the phase plate 19 is provided between the rising mirror 12 and the objective lens 13 as shown in FIG. 8C, laser light passing through the collimator lens 8 directly enters the rising mirror 9. The rising mirror 9 transmits most of short-wavelength laser light. in this case, differences are generated in the optical path lengths in the tangential and radial directions. After that, the laser light, which is reflected by the rising mirror 12, enters the phase plate 19 before or after passing through the achromatic lens 14, so that the optical path length of a part of the laser light is changed in the tangential direction. Accordingly, it may be possible to offset the differences in the optical path lengths in the tangential and radial directions, which are generated by the laser light passing through the rising mirror 9, by the difference d(n−1) in the optical path length in the tangential direction that is generated by the laser light passing through the phase plate 19. After that, the laser light enters the objective lens 13.

However, the phase steps 19a of the first embodiment correct astigmatism by using the fact that the diameter of laser light is changed by the thickness of a base material. Accordingly, if the phase plate 19 is disposed at a portion where the diameter of laser light is significantly changed, it may be possible to correct astigmatism more accurately. The change of the diameter of laser light, which is caused by the change of the thickness of a base material, is significant at a position that is further spaced apart from the objective lens. Accordingly, if the phase plate 19 is disposed between the collimator lens 8 and the objective lens 13, preferably, between the collimator lens 8 and the rising mirror 9 as shown in FIG. 8A, it may be possible to correct astigmatism more accurately.

Further, in the case of the position of the phase plate 19 shown in FIGS. 8B and 8C, long-wavelength laser light does not pass through the phase plate 19. Accordingly, the phase step 19a of the phase plate 19 may be determined in consideration of only short-wavelength laser light. In the case of the position of the phase plate 19 shown in FIG. 8A, long-wavelength laser light passes through the phase plate 19. If the size of long-wavelength laser light is set so that the long-wavelength laser light does not pass through the phase steps 19a of the phase plate 19, long-wavelength laser light is not affected by the phase steps 19a. Alternatively, even when the size of long-wavelength laser light is set so that the long-wavelength laser light passes through the phase steps 19a, it is preferable that the thickness of the phase step 19a be set to an integral multiple of the wavelength of the long-wavelength laser light. That is, assuming that the wavelength of long-wavelength light is represented by λ₂ and the refractive index of the phase plate 19 at the wavelength λ₂ is represented by n₂, and an arbitrary integer is represented by m, the thickness d of the phase step 19a is represented by mλ₂/(n₂−1). Accordingly, long-wavelength laser light is not affected by the phase step, and the astigmatism of long-wavelength laser light is corrected.

If the recording layer of the optical disk 2 is formed of multiple layers, the change in the thickness of a base material is increased. Accordingly, spherical aberration is increased. In order to correct the spherical aberration, the degree of convergence and divergence of laser light is further changed by the movement of the collimator lens 8 in the optical pickup device in the related art. As a result, the influence of astigmatism has been increased as shown in FIG. 7. However, in the optical pickup device according to the first embodiment, the phase plate 19 is disposed between the collimator lens 8 and the objective lens 13, and the phase steps 19a are provided at two sides of the phase plate 19 that face each other. Accordingly, when recording or reproduction is performed on the recording layer of which the thickness of a base material is small, the diameter of laser light is increased but the area of the laser light, which passes through the phase steps 19a and causes the change in the optical path length, is also increased. Therefore, it may be possible to offset the differences in the optical path lengths in the tangential and radial directions, which are generated by the laser light passing through the rising mirror 9, by the difference d(n−1) in the optical path length in the tangential direction that is generated by the laser light passing through the phase plate 19. Further, it may be possible to correct astigmatism as shown in FIG. 7.

Furthermore, since the phase plate 19 does not have polarization dependency, it may be possible to control the astigmatism not only of laser light directed to the optical disk 2 but also of light reflected from the optical disk 2 of which the polarization direction is different from that of the laser light directed to the optical disk 2. In addition, since the phase plate 19 made of glass or the like has been simply provided in the optical pickup device according to the first embodiment, the optical pickup device is inexpensive and does not require power or a specific system in order to correct astigmatism.

Second Embodiment

A second embodiment is formed by modifying the structure of the phase plate 19 that has been described in the first embodiment with reference to FIG. 3.

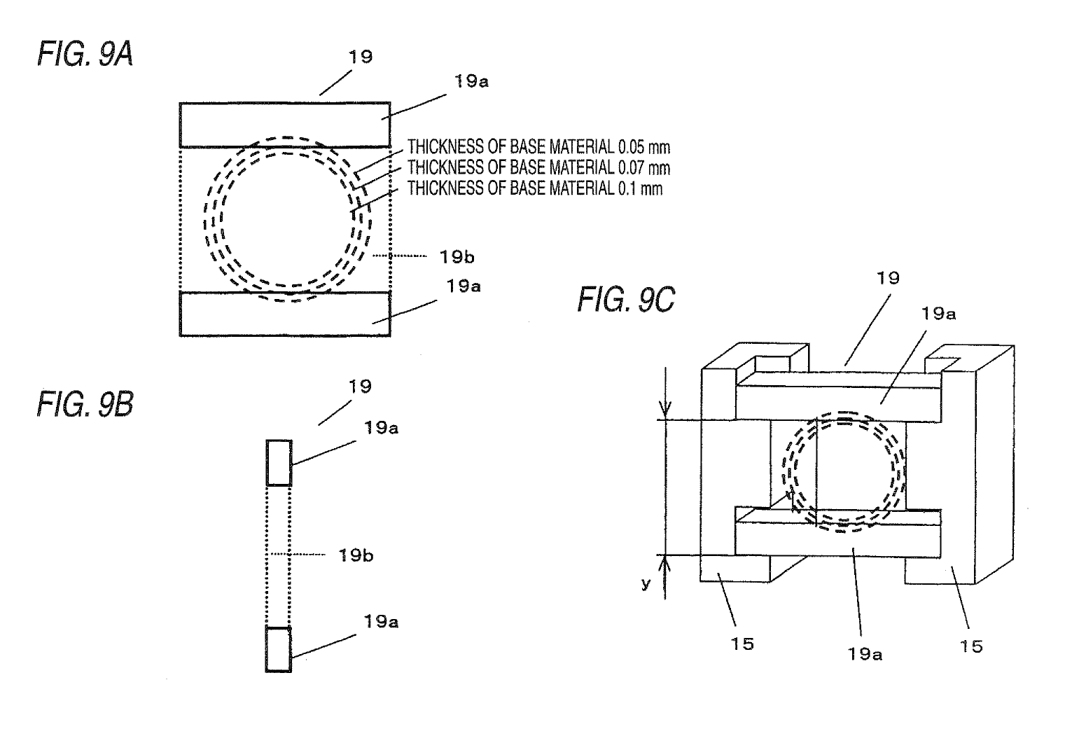

A phase plate 19 shown in FIGS. 9A and 9B is formed of only two phase steps 19a. That is, two phase steps 19a are disposed so as to be spaced apart from each other by a predetermined distance without a central portion 19b for connecting the phase steps 19a so that a part of laser light having a size larger than a predetermined size passes through the phase steps 19a, In the second embodiment, two phase steps 19a are disposed so that the thickness of a base material of the largest optical disk where a part of laser light passes through the phase steps 19a is 0.07 mm. Accordingly, if the thickness of a base material is 0.07 mm or more, all laser light passes through air.

Unlike in the cases of the phase plates 19 shown in FIGS. 3 to 6 and 10, two phase steps 19a should be disposed so as to be spaced apart from each other by a predetermined distance in the case of the phase plate 19 shown in FIGS. 9A and 9B. Accordingly, when the phase steps 19a are disposed so as to be spaced apart from each other in the tangential direction by a predetermined distance, for example, a portion of the base 15, where the phase plate 19 is mounted, is modified as shown in FIG. 9C and the phase plate 19 may be fixed by adhesion. When the phase steps 19a are disposed so as to be spaced apart from each other in the radial direction by a predetermined distance, the phase plate may be disposed in the same manner as the phase plates 19 shown in FIGS. 3 to 6 and 10. The distance between the two phase steps 19a, which determines the thickness of a base material of the largest optical disk where a part of laser light passes through the phase steps 19a, may be adjusted by the width y of the base 15.

A portion of the phase plate 19, where the phase steps 19a are not formed, is a portion through which all laser light passes as shown in FIG. 4A, and may not cause the difference in the optical path length of laser light. Accordingly, since the phase plate 19 is formed as shown in FIG. 9A, the phase plate 19 is formed of only the portions causing the difference in the optical path length of a part of the laser light that passes through the phase steps 19a of the phase plate 19 and causes the change in the optical path length and in the optical path length of a part of the laser light that does not pass through the phase steps 19a and does not cause the change in the optical path length. As a result, it may be possible to further reduce the size of the phase plate 19 and to reduce the cost.

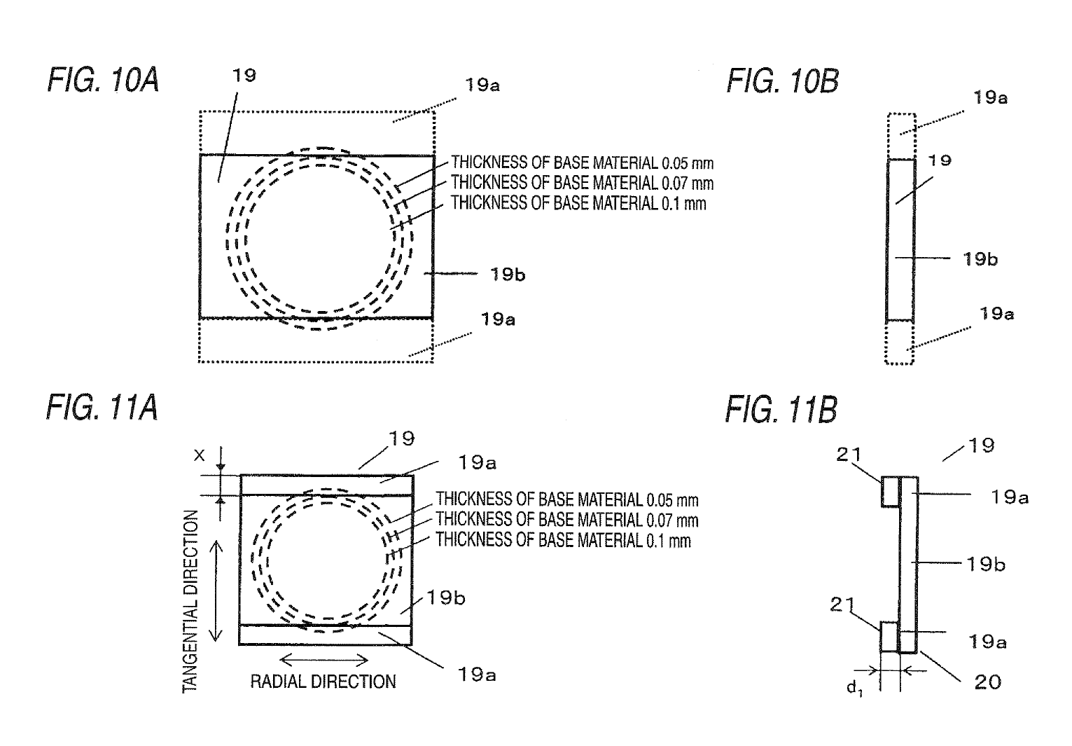

A phase plate 19 shown in FIGS. 10A and 10B is formed of only a central portion 19b by cutting out portions corresponding to the phase steps 19a, so that the thickness of each of the phase steps 19a becomes zero. Accordingly, a part of laser light having a size larger than a predetermined size passes through the phase steps 19a having a thickness of 0, that is, air. In the second embodiment, two phase steps 19a are disposed so that the thickness of a base material of the largest optical disk where a part of laser light passes through air, that is, the phase steps 19a is 0.07 mm. Accordingly, if the thickness of a base material is 0.07 mm or more, all laser fight passes through the phase plate 19.

Portions, where the phase steps 19a are not formed, of the phase plate 19 shown in FIG. 5A are portions through which all laser light passes, and may not cause the different in the optical path length of laser light. Accordingly, since the phase plate 19 is formed as shown in FIG. 10A, the phase plate 19 is formed of only the portions causing the difference in the optical path length of a part of the laser light that passes through the phase steps 19a of the phase plate 19 and causes the change in the optical path length and in the optical path length of a part of the laser light that does not pass through the phase steps 19a and does not cause the change in the optical path length. As a result, it may be possible to further reduce the size of the phase plate 19 and to reduce the cost.

Third Embodiment

A third embodiment is formed by modifying the structure of the phase plate 19 that has been described in the first embodiment with reference to FIG. 3.

Phase steps 19a of a phase plate 19 shown in FIGS. 11A and 11B are formed by laminating bonding members 21 on two sides of a flat base body 20 that face each other in the tangential direction. In this case, a central portion 19b is formed of only the base body 20. Phase steps 19a of a phase plate 19 shown in FIG. 12 are formed by laminating bonding members 21 on two sides of a flat base body 20 that face each other in the radial direction. Even in this case, a central portion 19b is formed of only the base body 20 as in the phase plate 19 shown in FIG. 11.

Assuming that the refractive index of the bonding member 21 is represented by n, the refractive index of air is 1, and the thickness of the bonding member 21 is represented by d₁, the optical path length of laser light is represented by d₁n when the laser light passing through the phase step 19a passes through the bonding member 21 and the optical path length of the laser light, which does not pass though the phase step 19a and passes through air by the same thickness as the thickness of the bonding member 21, is represented by d₁. Accordingly, a difference d₁(n−1) is generated in the optical path lengths of the laser light passing through the phase step 19a and the laser light passing through the central portion 19b. Therefore, it may be possible to offset the differences in the optical path lengths in the tangential and radial directions, which are generated by the laser light causing astigmatism that passes through the rising mirror 9, by the difference d₁(n−1) in the optical path length in one direction of the tangential and radial directions that is generated by the laser light passing through the phase plate 19. Meanwhile, assuming that the wavelength of light is represented by λ and the phase difference of the laser light passing through the phase step 19a is represented by Δ, the thickness d₁ of the bonding member 21 is represented by Δλ/(n−1). Δλ represents the difference in the optical path length of the laser light that passes through the phase step 19a.

Likewise, even in the case of the phase plate 19 shown in FIG. 12, the phase steps 19a may be provided at two sides of the base body 20 that face each other in the tangential direction as shown in FIG. 11A and may be provided at two sides of the base body that face each other in the radial direction as shown in FIG. 12. However, if the phase steps are provided at two sides of the base body that face each other in the tangential direction, the area of the laser light passing through the phase step 19a is not changed even when laser light is moved in the radial direction by tracking control or the like. Accordingly, it may be possible to correct astigmatism without difficulty.

Since the phase steps 19a are formed by laminating the bonding members 21 on two sides of the flat base body 20 that face each other, the central portion 19b is a portion of the base body 20 where the bonding members 21 are not laminated and the structure of the phase plate 19 is simplified. Accordingly, it may be possible to form the phase plate easily and design the phase plate easily.

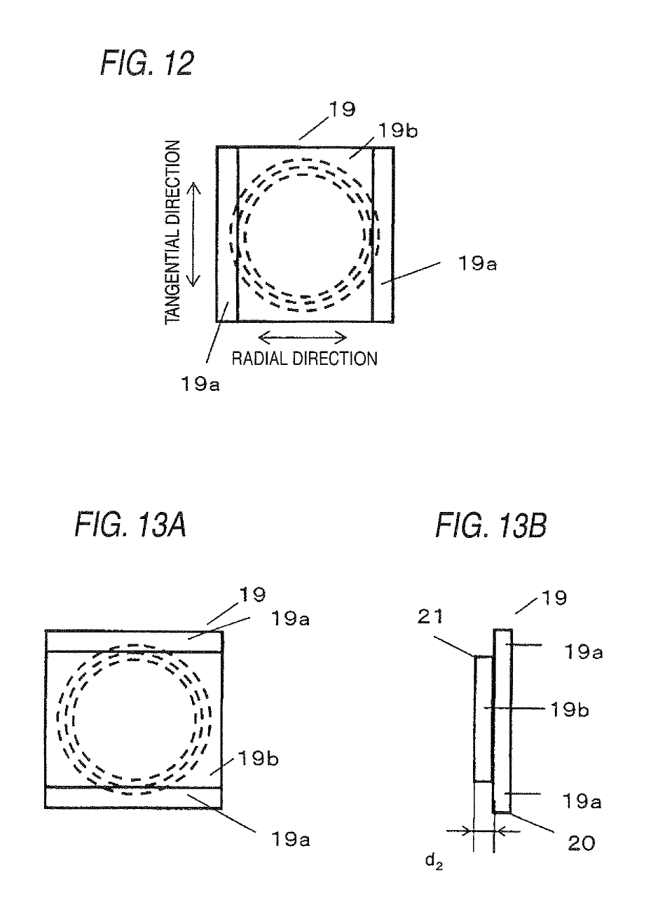

A central portion 19b of a phase plate 19 shown in FIG. 13A and 13B is formed by laminating a bonding member 21 on the center portion of a flat base body 20. In this case, phase steps 19a are formed of only the base body 20.

Assuming that the refractive index of the bonding member 21 of the phase plate 19 is represented by n, the refractive index of air is 1, and the thickness of the bonding member 21 is represented by d₂, the optical path length of laser light is represented by d₂n when the laser light passing through the central portion 19b passes through the bonding member 21 and the optical path length of the laser light, which passes though the phase step 19a and passes through air by the same thickness as the thickness of the bonding member 21, is represented by d₂. Accordingly, a difference d₂(n−1) is generated in the optical path lengths of the laser light passing through the central portion 19b and the laser light passing through the phase step 19a. Therefore, it may be possible to offset the differences in the optical path lengths in the tangential and radial directions, which are generated by the laser light causing astigmatism that passes through the rising mirror 9, by the difference d₂(n−1) in the optical path length in one direction of the tangential and radial directions that is generated by the laser light passing through the phase plate 19. Meanwhile, assuming that the wavelength of light is represented by λ and the phase difference of the laser light passing through the central portion 19b is represented by Δ, the thickness d₂ of the bonding member 21 is represented by Δλ/(n−1), Δλ represents the difference in the optical path length of the laser light that passes through the phase step 19a.

Meanwhile, the phase steps 19a may be provided at two sides of the base body 20 that face each other in the tangential direction, and may be provided at two sides of the base body that face each other in the radial direction.

Since the central portion 19b is formed by laminating the bonding member 21 on the center portion of the flat base body 20, the phase steps 19a are portions formed of only the base body 20 and the structure of the phase plate 19 is simplified. Accordingly, it may be possible to form the phase plate easily and design the phase plate easily.

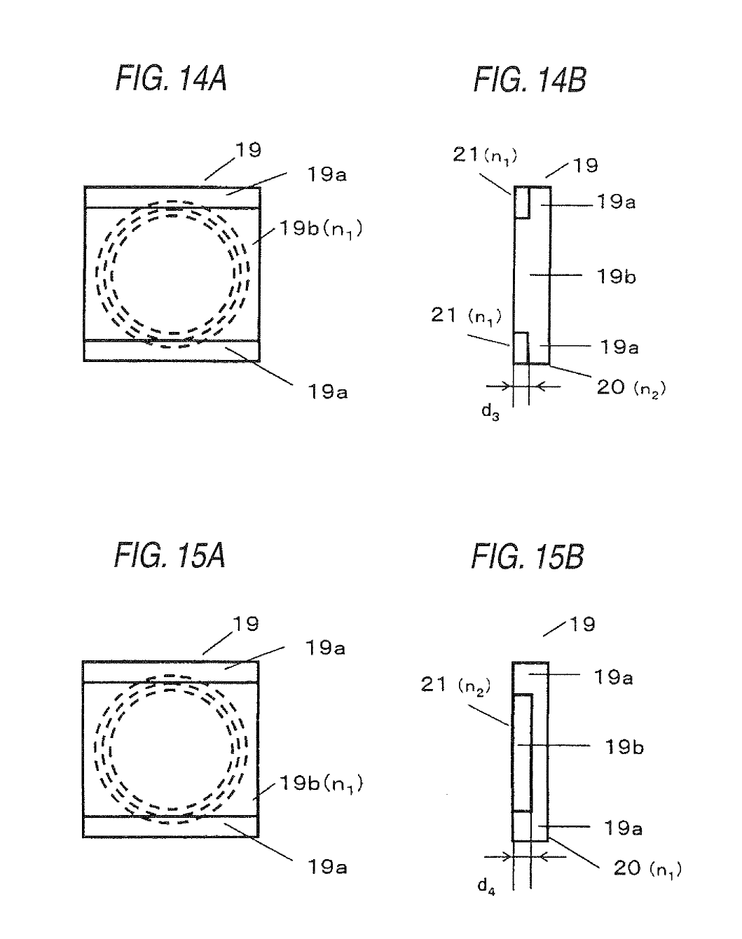

Phase steps 19a of a phase plate 19 shown in FIGS. 14A and 14B are formed by laminating bonding members 21 on thin portions of a base body 20 of which portions facing each other are formed to be thin. In this case, a central portion 19b is a thick portion of the base body 20.

Assuming that the refractive index of the bonding member 21 of the phase plate 19 is represented by n₁, the refractive index of the base body 20 is represented by n₂, and the thickness of the bonding member 21 is represented by d₃, the optical path length of laser light is represented by d₃n₁ when the laser light passing through the phase steps 19a passes through the bonding member 21 and the optical path length of laser light is represented by d₃n₂ when the laser light passes though only the base body 20 (which is the central portion 19b) and passes through the base body 20 by the same thickness as the thickness of the bonding member 21. Accordingly, a difference d₃(n₁-n₂) is generated in the optical path lengths of the laser light passing through the phase step 19a and the laser light passing though only the central portion 19b. Therefore, it may be possible to offset the differences in the optical path lengths in the tangential and radial directions, which are generated by the laser light causing astigmatism that passes through the rising mirror 9, by the difference d₃(n₁-n₂) in the optical path length in one direction of the tangential and radial directions that is generated by the laser light passing through the phase plate 19. Meanwhile, assuming that the wavelength of light is represented by λ and the phase difference of the laser light passing through the phase step 19a is represented by Δ, the thickness d₃ of the bonding member 21 is represented by Δλ/(n₁-n₂).

Since the phase steps 19a are formed by laminating the bonding members 21 on the thin portions of the base body 20 of which portions facing each other are formed to be thin as described above, the central portion 19b forms a thick portion of the base body 20 and steps formed by the thick and thin portions of the base body 20 are used as the reference for the mounting of the bonding member 21 so that the bonding members 21 are easily positioned. As a result, it may be possible to form the phase plate 19.

A central portion 19b of a phase plate 19 shown in FIG. 15A and 15B is formed by laminating a bonding member 21 on a thin portion of a base body 20. In this case, phase steps 19a are thick portions of the base body 20.

Assuming that the refractive index of the base body 20 of the phase plate 19 is represented by n₁, the refractive index of the bonding member 21 is represented by n₂, and the thickness of the bonding member 21 is represented by d₄, the optical path length of laser light is represented by d₄n₂ when the laser light passing through the central portion 19b passes through the bonding member 21 and the optical path length of laser light is represented by d₄n₁ when the laser light passing through the phase step 19a passes through the base body 20 by the same thickness as the thickness of the bonding member 21. Accordingly, a difference d₄(n₁-n₂) is generated in the optical path lengths of the laser light passing through the phase step 19a and the laser light passing though the central portion 19b. Therefore, it may be possible to offset the differences in the optical path lengths in the tangential and radial directions, which are generated by the laser light causing astigmatism that passes through the rising mirror 9, by the difference d₄(n₁-n₂) in the optical path length in one direction of the tangential and radial directions that is generated by the laser light passing through the phase plate 19. Meanwhile, assuming that the wavelength of light is represented by λ and the phase difference between the laser light passing through only the phase step 19a and the laser light passing through the central portion 19b is represented by Δ, the thickness d₄ of the bonding member 21 is represented by Δλ/(n₁-n₂).

Since the central portion 19b is formed by laminating the bonding member 21 on the thin portion of the base body 20 as described above, the phase steps 19a form thick portions of the base body 20 and steps formed by the thick and thin portions of the base body 20 are used as the reference for the mounting of the bonding member 21 so that the bonding members 21 are easily positioned. As a result, it may be possible to form the phase plate 19.

Various forms of the phase step 19a and the central portion 19b will be described below.

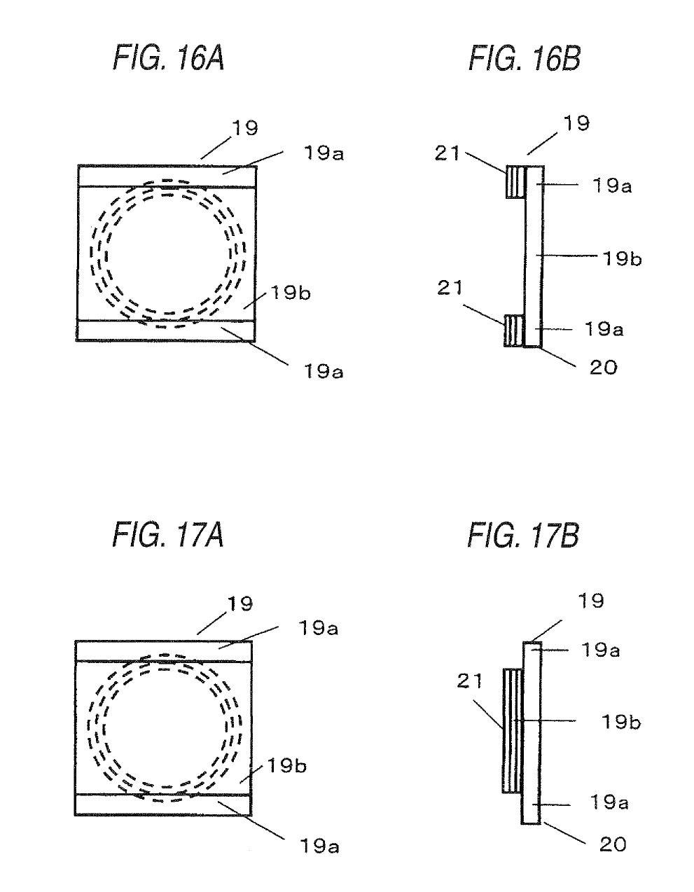

Bonding members 21 of each phase step 19a of a phase plate 19 shown in FIGS. 16A and 16B are formed by laminating materials having a plurality of different refractive indexes in a thickness direction of the phase plate 19. The phase steps 19a of the phase plate 19 shown in FIG. 16B have been formed by laminating the bonding members 21 on two sides of a flat base body 20, which face each other, in the thickness direction of the phase plate 19. However, the phase steps may be formed by laminating the bonding members 21 on thin portions of a base body 20 of which portions facing each other are formed to be thin.

Further, bonding members 21 of a central portion 19b of a phase plate 19 shown in FIGS. 17A and 17B are formed by laminating materials having a plurality of different refractive indexes in a thickness direction of the phase plate 19. The central portion 19b of the phase plate 19 shown in FIG. 17B has been formed by laminating the bonding members 21 on a center portion of a flat base body 20 in the thickness direction of the phase plate 19. However, the central portion 19b may be formed by laminating the bonding members on a center portion of a base body 20 of which a center portion is formed to be thin. Furthermore, three layers of bonding members 21 have been laminated in the first embodiment, but may be appropriately changed according to a desired difference between the optical path length of the laser light passing through the phase step 19a and the optical path length of the laser light not passing though the phase step.

Since the bonding members 21 are formed by laminating materials having a plurality of different refractive indexes in the thickness direction of the phase plate 19 as in the phase plates 19 shown in FIGS. 16 and 17, the degree of freedom of design is increased and the optical path length of laser light passing through the phase step 19a or the central portion 19b is apt to be controlled.

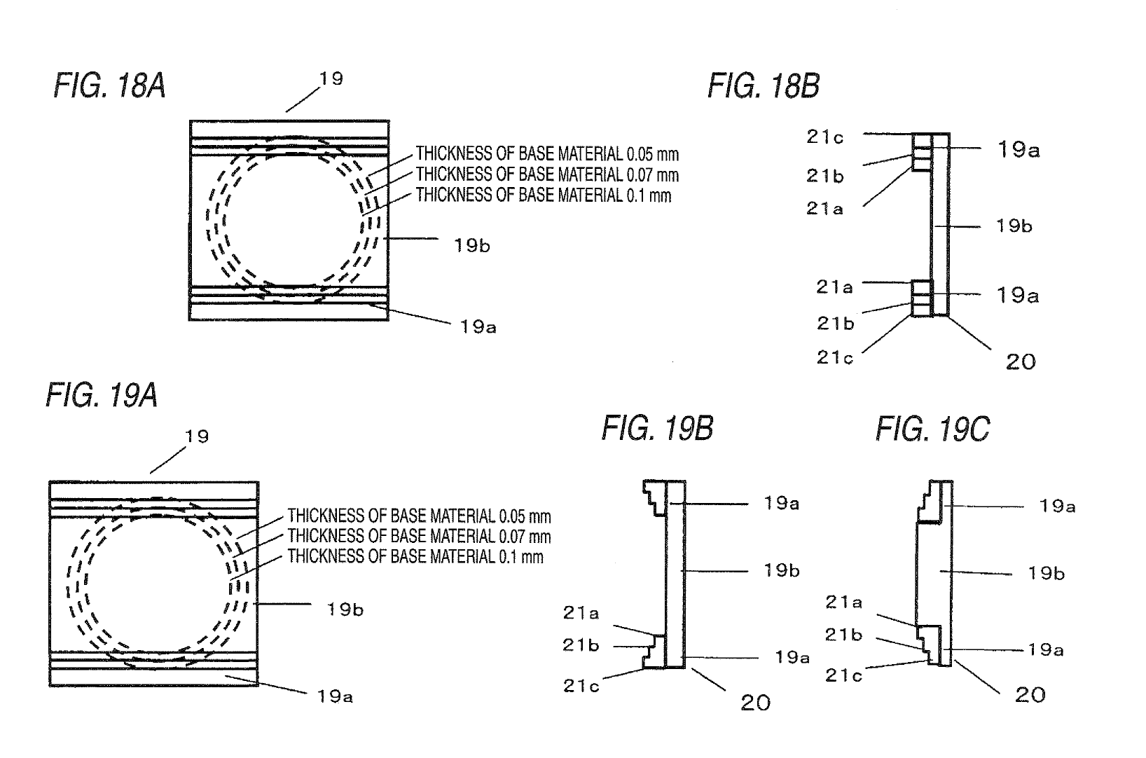

Bonding members 21a to 21c, which form phase steps 19a of a phase plate 19 shown in FIGS. 18A and 18B, are formed by laminating materials having a plurality of different refractive indexes on a flat base body 20 in a direction from the center of the phase plate 19 toward the outer end portions of the phase plate so that the refractive indexes are increased or decreased toward the end portions of the phase plate 19. Of course, phase steps may be formed by laminating these bonding members 21 on thin portions of a base body 20 of which portions facing each other are formed to be thin.

In FIG. 18A, the bonding members 21a to 21c, which form the phase steps 19a, are formed so that the thickness of a base material of the largest optical disk 2 where a part of laser light passes through the bonding member 21a is 0.1 mm, the thickness of a base material of the largest optical disk 2 where a part of laser light passes through the bonding member 21b is 0.07 mm, and the thickness of a base material of the largest optical disk 2 where a part of laser light passes through the bonding member 21c is 0.05 mm.

The bonding members 21a to 21c, which form the phase steps 19a of the phase plate 19, are formed by laminating materials having a plurality of different refractive indexes on the flat base body 20 in the direction from the center of the phase plate 19 toward the outer end portions of the phase plate so that the refractive indexes are increased or decreased toward the end portions of the phase plate 19. Accordingly, the refractive indexes of the phase steps 19a may be stepwise increased or decreased, so that it may be possible to correct astigmatism more accurately. Further, in this structure, it may be possible to make the heights of the phase steps 19a be equal to each other and to make the phase steps thin. Furthermore, since the diameter of the laser light entering the phase plate 19 is changed for the thickness of a base material of a plurality of recording surfaces of the optical disk 2 as shown in FIG. 18, the bonding members 21a to 21c may be provided so as to correspond to the size of the laser light to be used as shown in FIG. 18A. Meanwhile, if the number of bonding members 21a to 21c is larger when the phase steps 19a are formed of the bonding members that are made of materials having a plurality of different refractive indexes, it may be possible to correct astigmatism more accurately.

Phase plates 19 shown in FIGS. 19A to 19C are formed so that the cross-sections of bonding members 21a to 21c forming phase steps 19a stepwise become thick or thin toward the end portions of the phase plate 19. The phase plate 19 shown in FIG. 19B is formed by laminating bonding members 21 a to 21 c that become thick toward the end portions of the flat base body 20, and the phase plate 19 shown in FIG. 19C is formed by laminating bonding members 21a to 21c that become thin toward the end portions of the base body 20 of which two sides facing each other are formed to be thin. In this way, the bonding members 21a to 21c may become thick or thin toward the end portions of the phase plate 19 and the base body 20 may be flat and have two thin sides that face each other.

In FIG. 19A, the bonding members 21a to 21c are formed so that the thickness of a base material of the largest optical disk 2 where a part of laser light passes through the bonding member 21a is 0.1 mm, the thickness of a base material of the largest optical disk 2 where a part of laser light passes through the bonding member 21b is 0.07 mm, and the thickness of a base material of the largest optical disk 2 where a part of laser light passes through the bonding member 21c is 0.05 mm.

It may be possible to correct astigmatism more accurately by forming the phase plate 19 as described above. In particular, the diameter of the laser light entering the phase plate 19 is changed for the thickness of a base material of a plurality of recording surfaces of the optical disk 2, the bonding members 21a to 21c may be provided so as to correspond to the size of the laser light to be used as shown in FIG. 19A. Further, since the bonding members 21 a to 21 c are formed of one member, it may be possible to form the steps easily and accurately.

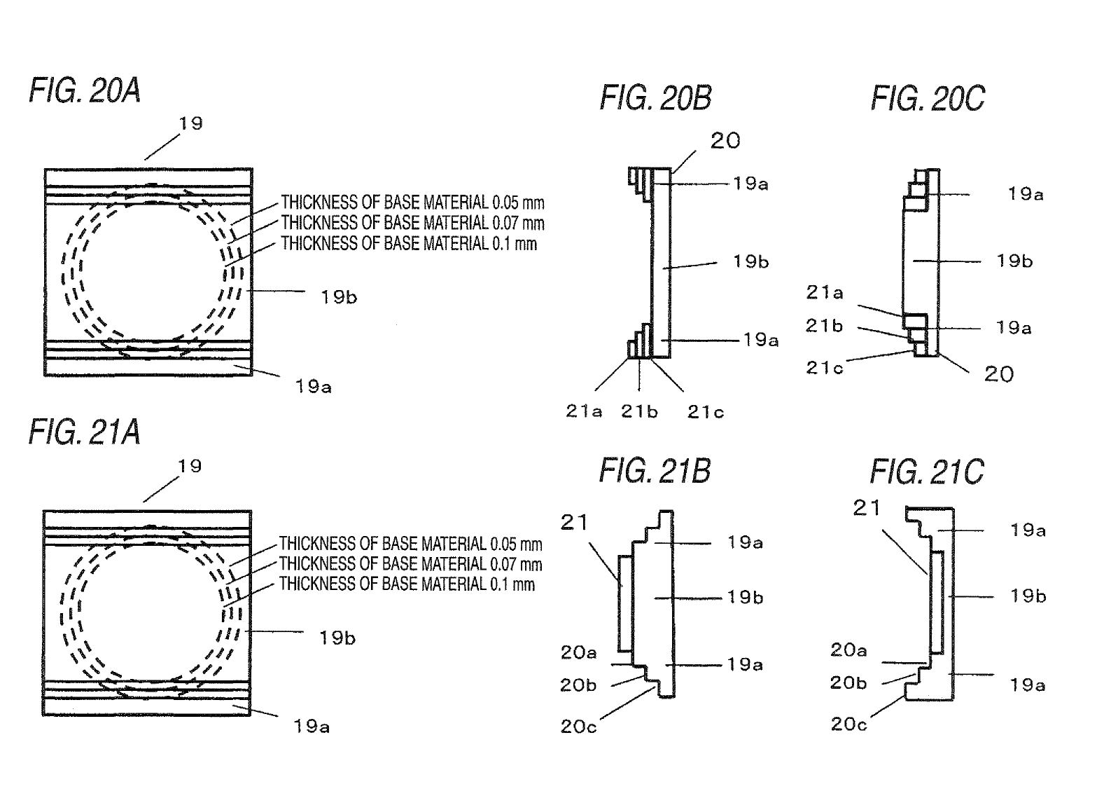

Bonding members 21a to 21c, which form phase steps 19a of phase plates 19 shown in FIGS. 20A to 20C, are formed by laminating materials having a plurality of different refractive indexes in a thickness direction of the phase plate 19 or in a direction from the center of the phase plate toward the outer end portions of the phase plate so that the cross-sections of the bonding members stepwise become thick or thin toward the end portions of the phase plate 19. The phase steps 19a of the phase plate 19 shown in FIG. 20B are formed by laminating bonding members 21a to 21c that become thick toward the end portions of the flat base body 20, and the phase steps 19a of the phase plate 19 shown in FIG. 20C are formed by laminating bonding members 21a to 21c that become thin toward the end portions of the base body 20 of which two sides facing each other are formed to be thin. In this way, the phase steps 19a may become thick or thin toward the end portions of the phase plate 19 and the base body 20 may be flat and have two thin sides that face each other. in addition, materials, which form the bonding members 21a to 21c, having a plurality of different refractive indexes may be laminated in the thickness direction of the phase plate 19, and may be laminated in a direction where the outer shape is increased from the center.

In FIG. 20A, the bonding members 21a to 21c are formed so that the thickness of a base material of the largest optical disk 2 where a part of laser light passes through the bonding member 21a is 0.1 mm, the thickness of a base material of the largest optical disk 2 where a part of laser light passes through the bonding member 21b is 0.07 mm, and the thickness of a base material of the largest optical disk 2 where a part of laser light passes through the bonding member 21c is 0.05 mm.

Since the phase plate 19 is formed as described above, the diameter of the laser light entering the phase plate 19 is stepwise changed for the thickness of a base material of a plurality of recording surfaces of the optical disk 2. It may be possible to correct astigmatism more accurately by forming the bonding members 21 in the shape of steps. Further, since the bonding members 21 are formed of materials having a plurality of different refractive indexes, the degree of freedom of design is increased and the optical path length of laser light passing through the phase step 19a is apt to be controlled.

A central portion 19b of a phase plate 19 shown in FIGS. 21A to 21C is formed by laminating a bonding member 21 on a center portion of a base body 20, and phase steps 19a are formed of steps 20a to 20c. The steps 20a to 20c are formed at portions, which face each other, of the base body 20 so that the cross-sections stepwise become thick or thin toward the end portions of the phase plate 19. Steps 20a to 20c, which become thin toward the end portions of the phase plate, are formed at the phase plate 19 shown in FIG. 21B. Steps 20a to 20c, which become thick toward the end portions of the phase plate, are formed at the phase plate 19 shown in FIG. 21C. As described above, the steps 20a to 20c may become thick or thin toward the end portions of the phase plate 19, and the center portion of the base body 20, which forms the central portion 19b, may be formed to be thick or thin.

In FIG. 21A, the bonding members 21a to 21c are formed so that the thickness of a base material of the largest optical disk 2 where a part of laser light passes through the bonding member 21a is 0.1 mm, the thickness of a base material of the largest optical disk 2 where a part of laser light passes through the bonding member 21b is 0.07 mm, and the thickness of a base material of the largest optical disk 2 where a part of laser light passes through the bonding member 21c is 0.05 mm.

Since the phase plate 19 is formed as described above, the diameter of the laser light entering the phase plate 19 is stepwise changed for the thickness of a base material of a plurality of recording surfaces of the optical disk 2. Accordingly, it may be possible to correct astigmatism more accurately by forming the steps 20a to 20c at the end portions of the base body 20 so that the phase plate is formed in the shape of steps.

If the recording layer of the optical disk 2 is formed of multiple layers, the change in the thickness of a base material is increased. Accordingly, spherical aberration is increased. In order to correct the spherical aberration, the degree of convergence and divergence of laser light is further changed by the movement of the collimator lens 8 in the optical pickup device in the related art. As a result, the influence of astigmatism has been increased. However, in the optical pickup device according to the first embodiment, the phase plate 19 is disposed between the collimator lens 8 and the objective lens 13, and the phase steps 19a are provided at two sides of the phase plate 19 that face each other. Accordingly, when recording or reproduction is performed on the recording layer of which the thickness of a base material is small, the diameter of laser light is increased but the area of the laser light, which passes through the phase steps 19a and causes the change in the optical path length, is also increased. Therefore, the differences in the optical path lengths in the tangential and radial directions, which are generated by the laser light passing through the rising mirror 9, may be offset by a difference between the optical path length of the laser light that passes through the phase step 19a by passing through the phase plate 19, and the optical path length of the laser light that does not pass though the phase step. As a result, it may be possible to correct astigmatism.

Further, since the phase plate 19 does not have polarization dependency, it may be possible to control the astigmatism of not only laser light directed to the optical disk 2 but also light reflected from the optical disk 2 of which the polarization direction is different from that of the laser light directed to the optical disk 2. In addition, since the phase plate 19 made of glass or the like has been merely provided in the optical pickup device according to the first embodiment, the optical pickup device is inexpensive and does not require power or a specific system in order to correct astigmatism. Furthermore, since the degree of freedom of design is increased by forming the phase step 19a and the central portion 19b of the phase plate 19 with different materials, it is apt to control the optical path length of laser light, to make the phase plate 19 thin, and to correct astigmatism accurately.

Fourth Embodiment

A fourth embodiment is formed by modifying the structure of the phase plate 19 that has been described in the first embodiment. In the fourth embodiment, a phase plate 19 is formed by coating a film on the base body 20 instead of the bonding member 21 shown in the third embodiment.

A phase step 19a or a central portion 19b of a phase plate 19 of the fourth embodiment is formed by coating an optical thin film, which is made of TA₂O₅, Nb₂O₃, Al₂O₃, or SiO₂, on a flat plate-shaped base body, which is made of a transparent resin material, silica, white sheet glass, or optical glass such as BK7. A sputtering method, a deposition method, and the like may be considered as a method of coating the optical thin film, and the optical thin film comes in close contact with the base body by being dried one time.

It may be possible to form phase steps 19a by coating a film on portions of a flat base body 20, which face each other, instead of the bonding members 21 that form the phase steps 19a of the phase plates 19 shown in FIGS. 11 and 12.

It may be possible to form a central portion 19b by coating a film on a center portion of a flat base body 20, instead of the bonding members 21 that form the central portions 19b of the phase plates 19 shown in FIGS. 13 and 21B.

It may be possible to form phase steps 19a by coating a film on thin portions of a base body 20 of which portions facing each other are formed to be thin, instead of the bonding members 21 that form the phase steps 19a of the phase plate 19 shown in FIG. 14.

It may be possible to form a central portion 19b by coating a film on a thin portion of a flat base body 20 of which a center portion is formed to be thin, instead of the bonding members 21 that form the central portions 19b of the phase plates 19 shown in FIGS. 15 and 21C.

Not only when laminated and coated films having a plurality of different refractive indexes are used instead of the bonding member 21 in the phase plates 19 shown in FIGS. 16 to 20 but also when stepwise laminated and coated films are used instead of the bonding member 21, it may be possible to laminate and form films easily.

Since the phase plate 19 is formed as described above, it may be possible to form the phase plate 19 easily by a simple process for coating films on the base body 20 and easily to control the thickness of the phase step 19a or the central portion 19b that is formed by coating films.

Fifth Embodiment

A fifth embodiment is formed by modifying the structure of the phase plate 19 that has been described in the first embodiment.

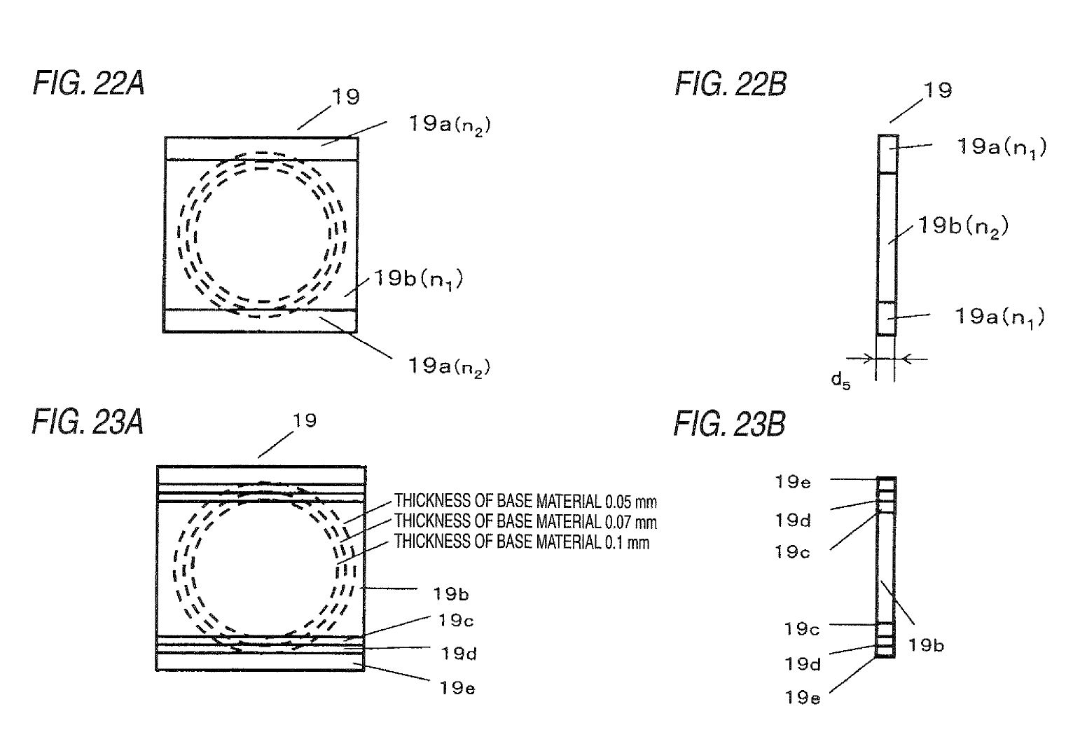

A phase plate 19 shown in FIGS. 22A and 22B is formed by connecting phase steps 19a to the outer surfaces of a central portion 19b that face each other. In this case, the thickness of the central portion 19b is not necessarily different from those of the phase steps 19a, and the thickness of the central portion may be equal to or different from those of the phase steps. A case where the thickness of the central portion 19b is equal to those of the phase steps 19a will be described below.

Assuming that the refractive index of the phase step 19a of the phase plate 19 is represented by n₁, the refractive index of the central portion 19b is represented by n₂, and the thickness of the phase plate 19 is represented by d₅, the optical path length of laser light is represented by d₅n₁ when the laser light passes through the phase step 19a and the optical path length of laser light passing through the central portion 19b is represented by d₅n₂. Accordingly, a difference d₅(n₁-n₂) is generated in the optical path lengths of the laser light passing through the phase step 19a and the laser light passing though the central portion 19b. Therefore, it may be possible to offset the differences in the optical path lengths in the tangential and radial directions, which are generated by the laser light causing astigmatism that passes through the rising mirror 9, by the difference d₅(n₁-n₂) in the optical path length in one direction of the tangential and radial directions that is generated by the laser light passing through the phase plate 19. Meanwhile, assuming that the wavelength of light is represented by λ and the phase difference of the laser light passing through the phase step 19a is represented by Δ, the thickness d₅ of the phase plate 19 is represented by Δλ/(n₁-n₂).

Since the phase plate 19 is formed by connecting phase steps 19a to the outer surfaces of the central portion 19b that face each other as described above, it may be possible to make the phase plate 19 thin and the symmetry of the phase plate 19 is secured. Accordingly, aberration is decreased, so that astigmatism may be accurately corrected.

Phase steps 19c to 19e of a phase plate 19 shown in FIGS. 23A and 23B are formed by laminating materials having a plurality of different refractive indexes in a direction from the center of the phase plate 19 toward the outer end portions of the phase plate so that the refractive indexes are increased or decreased toward the end portions of the phase plate 19. In FIG. 23A, the phase steps 19c to 19e are formed so that the thickness of a base material of the largest optical disk 2 where a part of laser light passes through the phase step 19c is 0.1 mm, the thickness of a base material of the largest optical disk 2 where a part of laser light passes through the phase step 19d is 0.07 mm, and the thickness of a base material of the largest optical disk 2 where a part of laser light passes through the phase step 19e is 0.05 mm.

Since phase steps 19c to 19e of the phase plate 19 are formed as described above by laminating materials having a plurality of different refractive indexes on the outer surfaces of the central portion 19b facing each other so that the refractive indexes are increased or decreased toward the end portions of the phase plate 19, it may be possible to make the phase plate 19 thin and the symmetry of the phase plate 19 is secured. Accordingly, aberration is decreased, so that astigmatism may be accurately corrected. Further, if the phase steps 19c to 19e are formed by laminating materials having a plurality of different refractive indexes so that the refractive indexes are increased or decreased toward the end portion of the phase plate 19, it may be possible to correct astigmatism more accurately. Meanwhile, since the diameter of the laser light entering the phase plate 19 is changed for the thickness of a base material of a plurality of recording surfaces of the optical disk 2, the phase steps 19c to 19e may be provided so as to correspond to the size of the laser light to be used as shown in FIG. 23A. Further, if the number of the phase steps 19c to 19e, which are made of material having different refractive indexes, is larger, it may be possible to correct astigmatism more accurately.

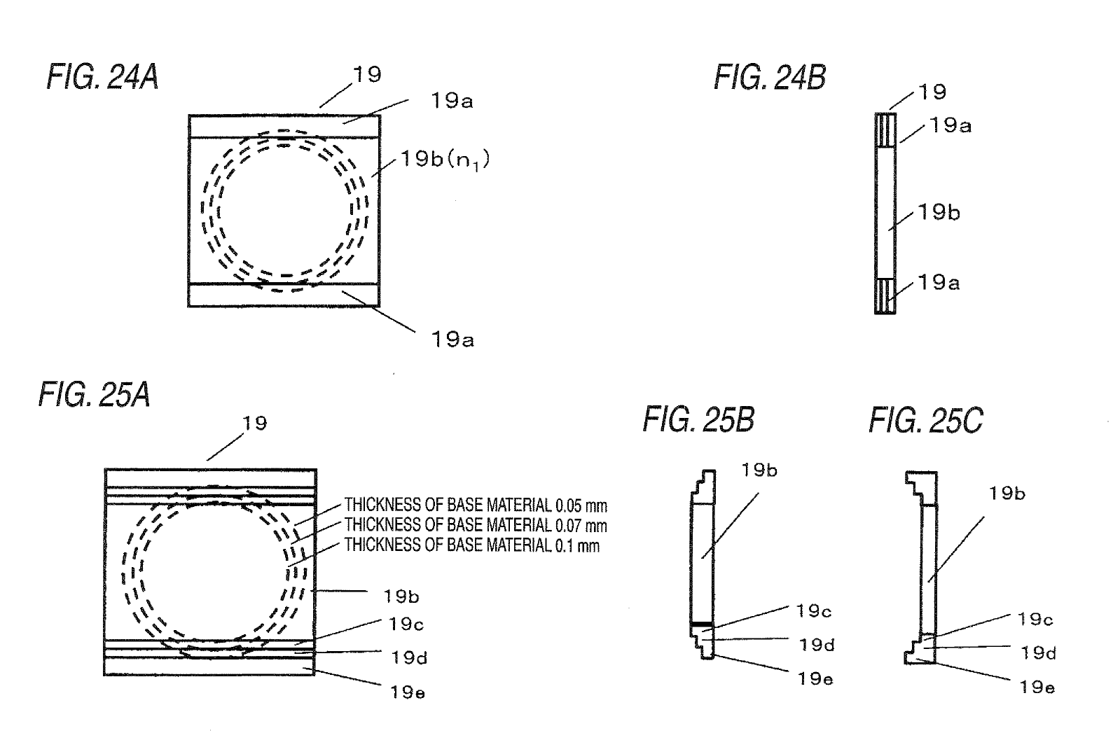

Phase steps 19a of a phase plate 19 shown in FIGS. 24A and 24B are formed by laminating materials having a plurality of different refractive indexes in a thickness direction. Three layers of phase steps 19a have been laminated in the third embodiment, but may be appropriately changed according to a desired difference between the optical path length of the laser light passing through the phase step 19a and the optical path length of the laser light not passing though the phase step.

Since the phase steps 19a are formed on the outer surfaces of the central portion 19b, which face each other, by laminating materials having a plurality of different refractive indexes in a thickness direction as described above, it may be possible to make the phase plate 19 thin and the symmetry of the phase plate 19 is secured. Accordingly, aberration is decreased, so that the accuracy of the correction of astigmatism may be improved. Further, since the phase steps 19a are formed by laminating materials having a plurality of different refractive indexes in the thickness direction, the degree of freedom of design is increased and the optical path length of laser light passing through the phase step 19a is apt to be controlled.

Phase plates 19 shown in FIGS. 25A to 25C are formed so that the cross-sections of phase steps 19c to 19e stepwise become thick or thin toward the end portions of the phase plate 19. That is, the phase plate 19 shown in FIG. 25B is formed so that the phase steps 19c to 19e become thin toward the end portions of the phase plate 19, and the phase plate 19 shown in FIG. 25C is formed so that the cross-sections of the phase steps 19c to 19e stepwise become thick toward the end portions of the phase plate 19.

In FIG. 25A, the phase steps 19c to 19e are formed so that the thickness of a base material of the largest optical disk 2 where a part of the laser light passes through the phase steps 19c is set to 0.1 mm, the thickness of a base material of the largest optical disk 2 where a part of the laser light passes through the phase steps 19d is set to 0.07 mm, and the thickness of a base material of the largest optical disk 2 where a part of the laser light passes through the phase steps 19e is set to 0.05 mm.

The cross-sections of the phase steps 19c to 19e stepwise become thick or thin toward the end portions of the phase plate 19 as described above, so that the diameter of the laser light entering the phase plate 19 is stepwise changed for the thickness of a base material of a plurality of recording surfaces of the optical disk 2. Accordingly, it may be possible to correct astigmatism more accurately by forming the phase steps 19c to 19e in the shape of steps. In addition, the phase plate 19 is made thin and the symmetry of the phase plate 19 is secured. Therefore, aberration is decreased, so that astigmatism may be more accurately corrected.

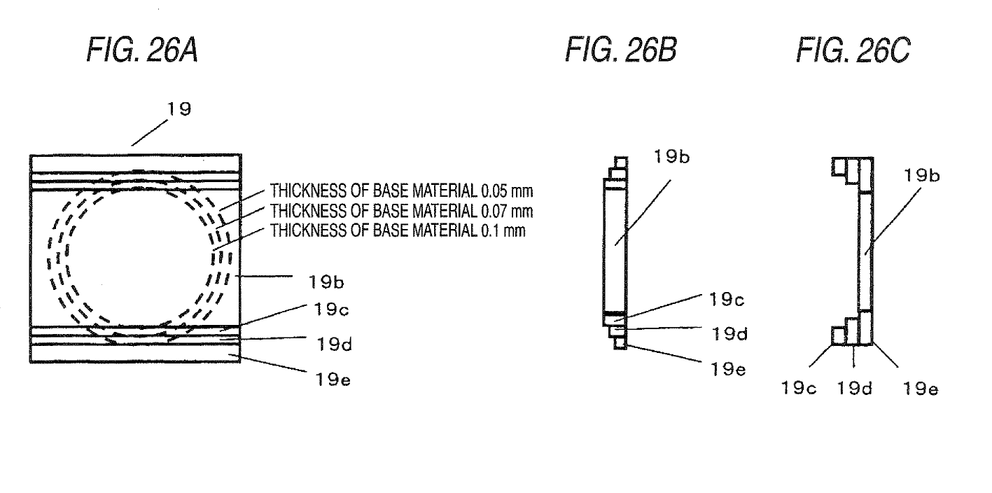

Phase steps 19c to 19e of phase plates 19 shown in FIGS. 26A to 26C, are formed by laminating materials having a plurality of different refractive indexes in a thickness direction of the phase plate or in a direction from the center of the phase plate 19 toward the outer end portions of the phase plate so that the cross-sections of the phase steps become thick or thin toward the end portions of the phase plate 19. That is, the phase plate 19 shown in FIG. 26B is formed by laminating the phase steps 19c to 19e in the direction from the center of the phase plate 19 toward the outer end portions of the phase plate so that the phase steps become thin toward the end portions of the phase plate 19, and the phase plate 19 shown in FIG. 26C is formed by laminating the phase steps 19c to 19e in the thickness direction of the phase plate 19 so that the phase steps become thick toward the end portions of the phase plate 19. In this way, the phase steps 19c to 19e may become thick or thin toward the end portions of the phase plate 19. In addition, the materials having a plurality of different refractive indexes may be laminated in the thickness direction of the phase plate 19, and may be laminated in a direction where the outer shape is increased from the center.

In FIG. 26A, the phase steps 19c to 19e are formed so that the thickness of a base material of the largest optical disk 2 where a part of the laser light passes through the phase steps 19c is set to 0.1 mm, the thickness of a base material of the largest optical disk 2 where a part of the laser light passes through the phase steps 19d is set to 0.07 mm, and the thickness of a base material of the largest optical disk 2 where a part of the laser light passes through the phase steps 19e is set to 0.05 mm.

Since the phase steps 19c to 19e are formed by laminating materials having a plurality of different refractive indexes in the thickness direction of the phase plate 19 or in the direction from the center toward the end portions so that the cross-sections of the phase steps become thick or thin toward the end portions of the phase plate 19, the diameter of the laser light entering the phase plate 19 is stepwise changed for the thickness of a base material of a plurality of recording surfaces of the optical disk 2. Accordingly, it may be possible to correct astigmatism more accurately by forming the phase steps 19c to 19e in the shape of steps. Further, the phase plate 19 is made thin and the symmetry of the phase plate 19 is secured. Therefore, aberration is decreased, so that astigmatism may be more accurately corrected. In addition, since the phase steps 19c to 19e are made of materials having a plurality of different refractive indexes, the degree of freedom of design is increased and the optical path lengths of laser light passing through the phase steps 19c to 19e are apt to be controlled.

Sixth Embodiment

An optical disk apparatus using the optical pickup device, which has been described in the first to fifth embodiments, will be described in a sixth embodiment.

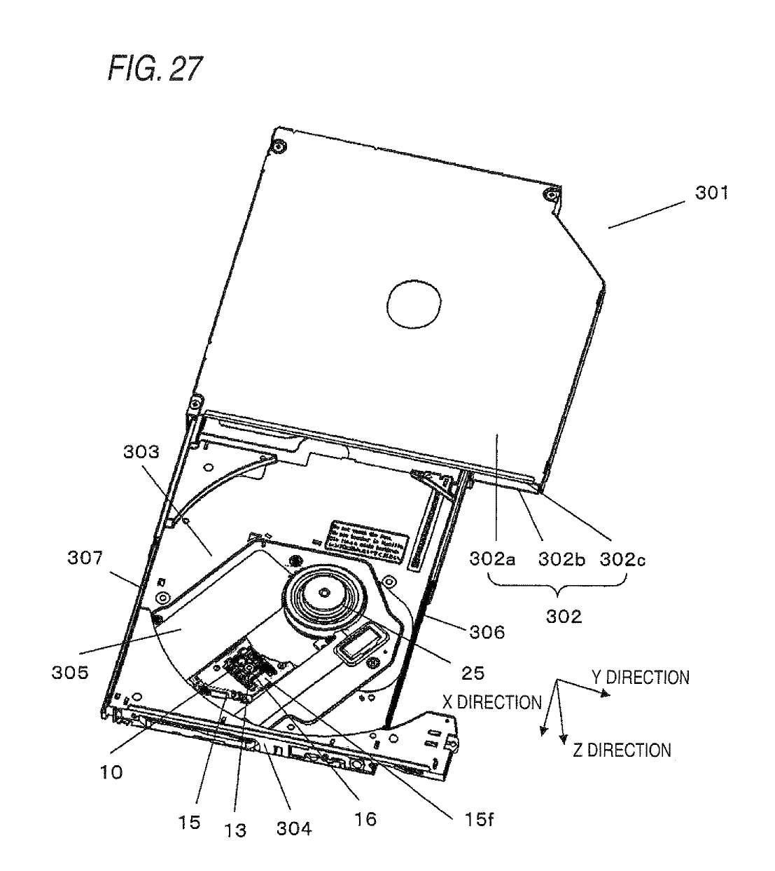

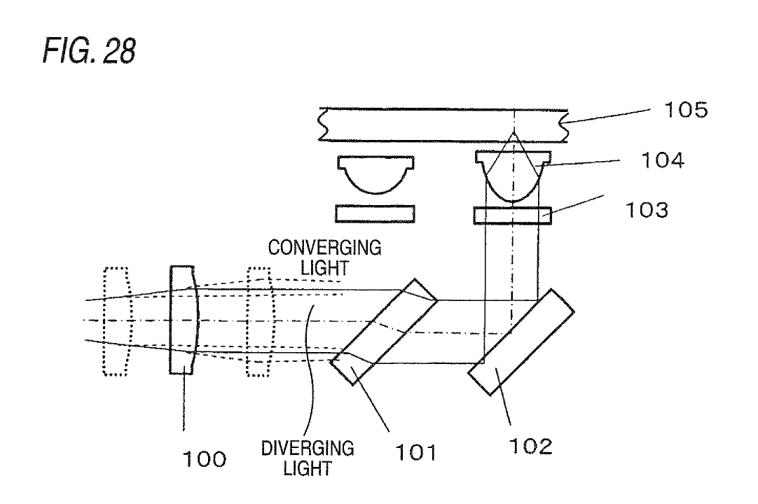

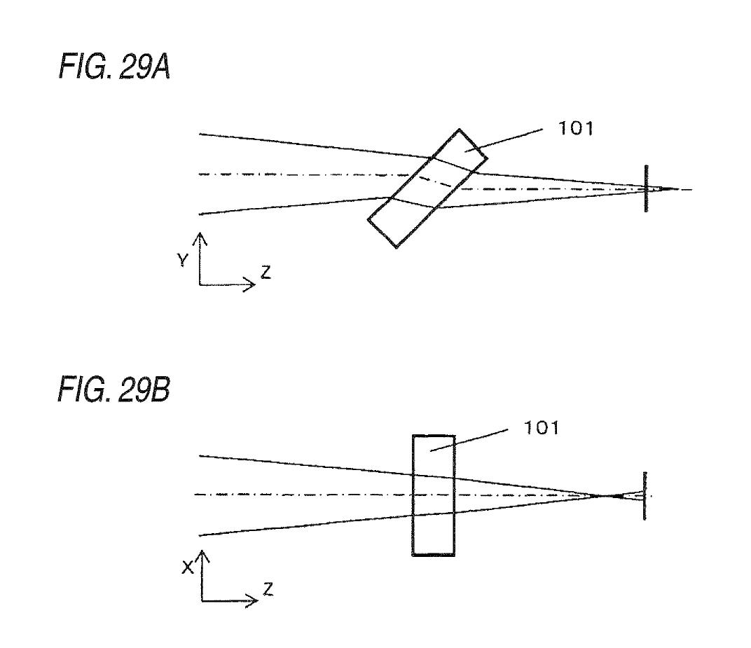

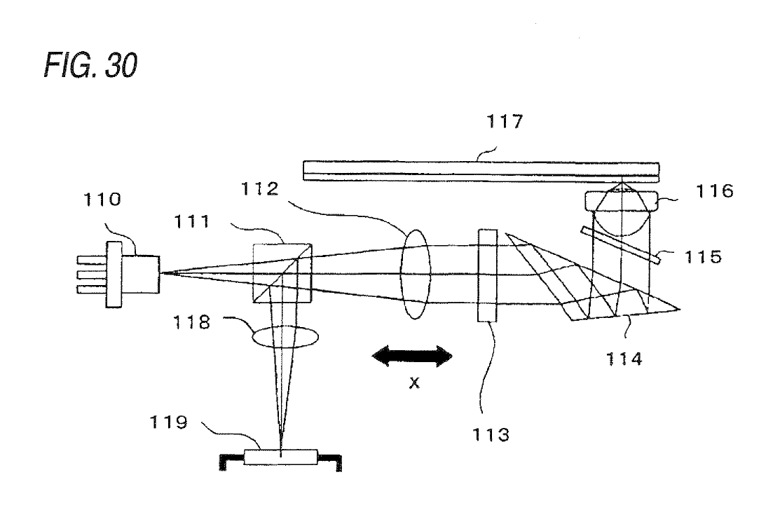

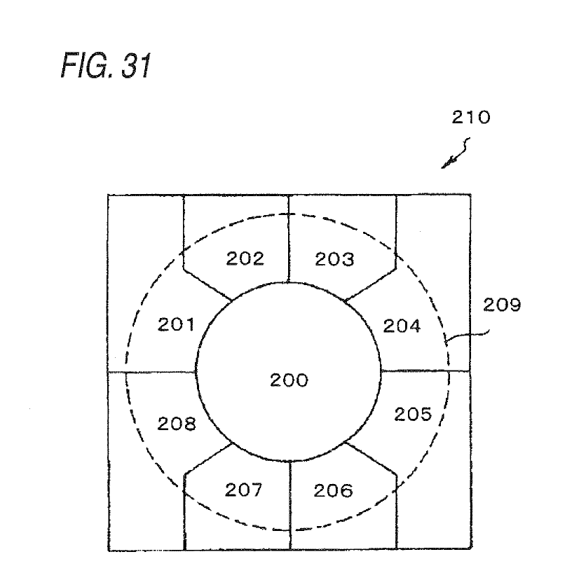

FIG. 27 is a perspective view of an optical disk apparatus according to a sixth embodiment that uses the optical pickup device described in the first to fifth embodiments. In an optical disk apparatus 301 shown in FIG. 27, reference numeral 302 denotes a cover, the cover 302 includes an upper cover 302a and a lower cover 302b, and cover 302 has a pouched structure where an opening 302c is formed at one end portion of the cover. A tray 303 is held in the cover 302 so as to be freely inserted and extracted in an X direction shown in FIG. 27, and the tray 303 is made of a light material such as a resin material. A bezel 304 is provided at the front portion of the tray 303, and the bezel 304 closes the opening 302c when the tray 303 is received in the cover 302. The bezel 304 is provided with an eject button. If the eject button is pressed, the tray 303 is slightly projected from the cover 302 in the X direction shown in FIG. 27 by a mechanism (not shown), so that the tray 303 can be inserted into and extracted from the cover 302 in the X direction.

The optical pickup device 305, which has been described in the first to fifth embodiments, is mounted on the tray 303. The optical pickup device 305 includes a spindle motor 25 that rotationally drives an optical disk 2, and the base 15 that is movably provided so as to approach and separate from the spindle motor 25. A lens holder 16 is mounted on the base 15 so as to be elastically movable with respect to the base 15. The objective lenses 10 and 13 and the like are mounted on the lens holder 16. A base cover 15f formed of a metal plate is mounted on the surface of the base 15 that faces the information recording surface of the optical disk loaded on the spindle motor 25, and covers at least a part of components such as a flexible substrate and the lens holder 16 that are mounted on the base 15. Accordingly, it may be possible to prevent the components, which are mounted on the base 15, from coming in contact with the optical disk, and to protect the components from dust, electrical noise, and the like.

Reference numerals 306 and 307 denote rails that are held on the lower cover 302b and are engaged with both sides of the tray 303. The rails 306 and 307 are provided so as to slide with respect to the lower cover 302b and the tray 303 in a predetermined range in the X direction where the tray 303 is inserted and extracted. Since the optical pickup device 305 described in the first and fifth embodiments of the invention is mounted on the optical disk apparatus shown in FIG. 27, it may be possible to offset the differences in the optical path lengths in the tangential and radial directions, which are generated by the laser light that is emitted from the short-wavelength optical unit 1 and passes through the rising mirror 9, by the difference d(n−1) in the optical path length that is generated by the laser light passing through the phase plate 19. Further, it may be possible to correct astigmatism. Furthermore, since the phase plate 19 does not have polarization dependency unlike liquid crystal, it may be possible to correct the astigmatism of not only laser light directed to the optical disk but also light reflected from the optical disk of which the polarization direction is different from that of the laser light directed to the optical disk. Accordingly, it may be possible correctly to record or reproduce information in or from a multilayer optical disk without redundancy. In addition, since the phase plate 19 made of glass or the like has been simply provided in the optical disk apparatus according to the sixth embodiment, the optical disk apparatus is inexpensive and may correct astigmatism without power or a specific system.

Further, the optical pickup device and the optical disk apparatus according to the invention may correct astigmatism, which is generated when recording or reproduction is performed on the recording surface of, particularly, a multilayer optical disk, without power or a specific system. Furthermore, the optical pickup device and the optical disk apparatus may have an advantage of correctly recording or reproducing information, and be applied to a portable electronic device such as a laptop personal computer or an electronic device such as a desktop personal computer.

This application claims the benefit of Japanese Patent application No. 2009-016198 filed on Jan. 28, 2009, and Japanese Patent application No. 2009-063848 filed on Mar. 17, 2009, the entire contents of which are incorporated herein by reference.

What is claimed is:

1. An optical pickup device comprising:
a light source that emits laser light;
a movable condensing lens that converts the laser light into converging light or diverging light;
a rising prism or a rising mirror that converts an optical axis of laser light passing through the condensing lens into a substantially vertical direction;
an objective lens that condenses the laser light, of which the optical axis is converted by the rising prism or the rising mirror, to an optical disk; and
a phase plate provided between the condensing lens and the objective lens, and including stepped portions that are formed at portions facing each other and have different thicknesses,
wherein the phase plate corrects astigmatism, which is generated by the rising prism or the rising mirror, by making a part of laser light having a size larger than a predetermined size pass through the stepped portions of the phase plate.

2. The optical pickup device according to claim 1, wherein the phase plate is provided between the condensing lens and the rising prism or the rising mirror.

3. The optical pickup device according to claim 1, wherein the phase plate includes the stepped portions that are formed at portions facing each other and have different thicknesses, and a central portion that is provided between the two stepped portions.

4. The optical pickup device according to claim 3, wherein the stepped portions provided at the phase plate are formed to be thicker than the central portion.

5. The optical pickup device according to claim 3, wherein the stepped portions provided at the phase plate are formed to be thinner than the central portion.

6. The optical pickup device according to claim 1, wherein the stepped portions provided at the phase plate are formed in a linear shape.

7. The optical pickup device according to claim 1, wherein the stepped portions provided at the phase plate are wholly or partially formed in a substantially circular arc shape so as to correspond to the shape of laser light.

8. The optical pickup device according to claim 1, wherein the stepped portions provided at the phase plate are formed so that the cross-sections of the stepped portions stepwise become thick or thin toward the end portions of the phase plate.

9. The optical pickup device according to claim 1, wherein the phase plate is formed of only the two stepped portions.

10. The optical pickup device according to claim 1, wherein the phase plate is formed of only a central portion by cutting out portions corresponding to the stepped portions, so that the thickness of each of the phase steps becomes zero.

11. The optical pickup device according to claim 1, wherein the stepped portions of the phase plate are formed by laminating a flat base body and bonding members.

12. The optical pickup device according to claim 11, wherein the stepped portions provided at the phase plate are formed by laminating the bonding members on portions of the flat base body that face each other.

13. The optical pickup device according to claim 11, wherein the stepped portions provided at the phase plate are formed by laminating the bonding members on a center portion of the flat base body.

14. The optical pickup device according to claim 11, wherein the stepped portions provided at the phase plate are formed by laminating the bonding members on thin portions of a base body of which portions facing each other are formed to be thin.

15. The optical pickup device according to claim 11, wherein the stepped portions provided at the phase plate are formed by laminating the bonding members on thin portions of a base body.

16. The optical pickup device according to claim 11, wherein the stepped portions provided at the phase plate are formed by laminating materials that have a plurality of different refractive indexes.

17. The optical pickup device according to claim 2, wherein the stepped portions provided at the phase plate are formed by coating a film on a base body.

18. An optical pickup device comprising:
laser light;
a movable condensing lens that converts the laser light into converging light or diverging light;
a converting part that converts an optical axis of laser light passing through the condensing lens into a substantially vertical direction;
an objective lens that condenses the laser light, of which the optical axis is converted by the converting part, to an optical disk; and
a phase plate provided between the condensing lens and the objective lens, and including stepped portions that are formed at portions facing each other and have different thicknesses,
wherein the phase plate corrects astigmatism, which is generated by the converting part, by making a part of laser light having a size larger than a predetermined size pass through the stepped portions of the phase plate.

19. An optical disk apparatus comprising:
a light source that emits laser light;
a movable condensing lens that converts the laser light into converging light or diverging light;
a rising prism or a rising mirror that converts an optical axis of laser light passing through the condensing lens into a substantially vertical direction;
an objective lens that condenses the laser light, of which the optical axis is converted by the rising prism or the rising mirror, to an optical disk;
a phase plate provided between the condensing lens and the objective lens, and including stepped portions that are formed at portions facing each other and have different thicknesses;
rotational driving means for rotating an optical disk; and
moving means for moving the optical pickup device with respect to the rotational driving means in a radial direction of the optical disk,
wherein the phase plate corrects astigmatism, which is generated by the rising prism or the rising mirror, by making a part of laser light having a size larger than a predetermined size pass through the stepped portions of the phase plate.
